(19) United States
(12) Patent Application Publication
(10) Pub. No.: US 2019/0384468 A1
(43) Pub. Date: Dec. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Masato ANDO, Kanagawa (JP)

(73) Assignee: FUJI XEROX CO., LTD., Tokyo (JP)

(21) Appl. No.: 16/433,690

(22) Filed: Jun. 6, 2019

(30) Foreign Application Priority Data
Jun. 15, 2018 (JP) 2018-115012
Jun. 15, 2018 (JP) 2018-115013

(51) Int. Cl. G06F 3/0484

(52) U.S. Cl. CPC G06F 3/0484

(57) ABSTRACT

An information processing apparatus includes: a display unit configured to display a relationship diagram that is created according to an operation by an operator and expresses a relationship between a plurality of items by connecting the plurality of items together with relationship lines; and an output unit configured to output a display element indicating second data relevant to first data corresponding to at least one of the plurality of items in such a way that the display element is displayed on the relationship diagram.

### CROSS-REFERENCE TO RELATED APPLICATIONS

This application is based on and claims priority under 35 USC 119 from Japanese Patent Application No. 2018-115012 filed Jun. 15, 2018 and Japanese Patent Application No. 2018-115013 filed Jun. 15, 2018.

### BACKGROUND

### (i) Technical Field

The present disclosure relates to an information processing apparatus and a non-transitory computer readable medium.

### (ii) Related Art

A known information processing apparatus performs the following information processing (see, e.g., JP-A-2014-112338). A selection unit selects an item in a quality function deployment table according to a selection operation by an operator. A first calculation unit calculates the relevance between the selected first item and an item that belongs to an axis adjacent to an axis to which the first item belongs. A first extraction unit compares the relevance with a predetermined value and extracts a second item relevant to the first item. A second calculation unit calculates the relevance between the first item and an item that belongs to an axis adjacent to the axis to which the second item belongs, from the relevance between the extracted second item and the item that belongs to the axis adjacent to the axis to which the second item belongs. A second extraction unit compares the relevance with a predetermined value and extracts a third item relevant to the first item. A display unit displays the first, second, and third items in different forms from those of other items.

When a relationship diagram that expresses a relationship between multiple items by connecting the multiple items together with relationship lines is created according to an operation by an operator, there is a possibility that the relationship between the multiple items may not indicate the relationship between data corresponding to an item and data relevant to the corresponding data. On such a relationship diagram, however, the operator cannot know the relationship between such pieces of data.

If a display element indicating the relationship between data corresponding to an item and data relevant to the corresponding data is displayed on a relationship diagram that expresses the relationship between multiple items by connecting the multiple items together with relationship lines, the display element may be displayed considering the relationship lines between the multiple items in a uniform way. However, if such a configuration is adopted, a display element indicating an unintended relationship will be more likely to be displayed.

### SUMMARY

Aspects of non-limiting embodiments of the present disclosure relate to notifying an operator of a relationship between data corresponding to an item and data relevant to the corresponding data when a relationship diagram that expresses a relationship between multiple items by connecting the multiple items together with relationship lines is created according to an operation by the operator.

Aspects of non-limiting embodiments of the present disclosure also relate to reducing the possibility that a display element indicating an unintended relationship will be displayed on a relationship diagram, as compared to a case where the display element is displayed considering relationship lines between multiple items in a uniform way, when the display element indicates a relationship between data corresponding to an item and data relevant to the corresponding data and the relationship diagram expresses a relationship between multiple items by connecting the multiple items together with relationship lines.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a display unit configured to display a relationship diagram that is created according to an operation by an operator and expresses a relationship between multiple items by connecting the multiple items together with relationship lines; and an output unit configured to output a display element indicating second data relevant to first data corresponding to at least one of the multiple items in such a way that the display element is displayed on the relationship diagram.

### BRIEF DESCRIPTION OF THE DRAWINGS

Exemplary embodiments of the present disclosure will be described in detail based on the following figures, wherein:

FIG. 1 is a conceptual module configuration diagram illustrating an example of a configuration of an exemplary embodiment;

FIG. 2 is an explanatory view illustrating an example of a data structure of a relationship diagram information table:

FIG. 3 is an explanatory view illustrating an example of a data structure of an item information table;

FIG. 4 is an explanatory view illustrating an example of a data structure of a relationship line information table;

FIG. 5 is an explanatory view illustrating an example of a data structure of an element analysis information table;

FIG. 6 is an explanatory view illustrating an example of a data structure of a relationship analysis information table;

FIG. 7 is an explanatory view illustrating an example of a system configuration using the present exemplary embodiment;

FIG. 8 is an explanatory view of an example of a technology which is a target of a relationship diagram and a deployment table:

FIG. 9 is an explanatory view illustrating an example of a relationship diagram;

FIG. 10 is an explanatory view illustrating an example of a relationship diagram;

FIG. 11 is an explanatory view illustrating an example of a relationship diagram:

FIG. 12 is an explanatory view illustrating an example of a deployment table;

FIG. 13 is an explanatory view illustrating an example of a screen:

FIG. 14A is a flowchart illustrating an example of a processing according to the present exemplary embodiment:

FIG. 14B is an explanatory view illustrating an example of a processing according to the present exemplary embodiment;

FIG. 14C is an explanatory view illustrating an example of a processing according to the present exemplary embodiment;

FIG. 15 is an explanatory view illustrating an example of a processing on a relationship diagram according to the present exemplary embodiment;

FIG. 16 is a flowchart illustrating an example of a processing according to the present exemplary embodiment:

FIG. 17 is an explanatory view illustrating an example of a processing according to the present exemplary embodiment;

FIG. 18 is a flowchart illustrating an example of a processing according to the present exemplary embodiment:

FIG. 19 is an explanatory view illustrating an example of a processing according to the present exemplary embodiment;

FIG. 20 is a flowchart illustrating an example of a processing according to the present exemplary embodiment;

FIG. 21 is an explanatory view illustrating an example of a processing according to the present exemplary embodiment;

FIG. 22 is a conceptual module configuration diagram illustrating an example of a configuration of the present exemplary embodiment;

FIG. 23 is an explanatory view illustrating an example of a processing on a relationship diagram according to the present exemplary embodiment;

FIG. 24 is a flowchart illustrating an example of a processing according to the present exemplary embodiment:

FIG. 25 is an explanatory view illustrating an example of a processing according to the present exemplary embodiment;

FIG. 26 is a flowchart illustrating an example of a processing according to the present exemplary embodiment; and

FIG. 27 is an explanatory view illustrating an example of a hardware configuration of the present exemplary embodiment.

### DETAILED DESCRIPTION

Hereinafter, an exemplary embodiment of the present disclosure will be described in detail with reference to the accompanying drawings.

In a system using a complex physical phenomenon, it is general that a large number of events are successively connected together, for example, in the manner that there exist multiple events that are causes of an event of a result such as the final quality of a product, there exist other multiple events that are causes of the events, and further, there exist other multiple events that are causes of the events. In such a complicated system, since there are lots of quality that need to be satisfied, the causal relationship between the group of causes and the group of results become very complicated. Thus, it may be difficult to find out design items (causes) for satisfying a desired quality (result), and a problem may easily occur, for example, in that a change of a design value for satisfying a specific quality adversely affects another quality.

A relationship diagram is one of diagrams which is used for visualizing and clarifying the complicated causal relationship. A relationship diagram expresses the causal relationship by connecting results and causes together with relationship lines, and a typical example of the relationship diagram is a logic tree. A relationship diagram is suitable for thoroughly indicating the results and the causes in a detailed manner.

However, the relationship diagram where events are expressed in language and itemized to indicate the relationship between the items is merely a hypothesis and is unlikely to indicate a relationship between actual data elements. Accordingly, it is necessary to compare and verify the relationship between the relationship between the items and the relationship between the actual data elements. Meanwhile, it may be difficult to acquire data elements corresponding to all items, and it may be necessary to indicate the relationship between data elements in the relationship between items according to the hypothesis.

In a case where the causal relationship between events is estimated by classifying the events into a result and a cause thereof from data, an unintended causal relationship may be indicated according to a setting of a target project. When the causal relationship between events is known in advance, it is effective to estimate the causal relationship according to data in a state where the known causal relationship is fixed. However, in a system using a complex physical phenomenon, since many events are connected together in the successive and crossing manner, it is difficult to thoroughly extract the causal relationship.

Thus, an exemplary embodiment of the present disclosure performs an analysis of data elements corresponding to items of a relationship diagram (analysis of data elements) or an analysis of a relationship between data elements corresponding to items of the relationship diagram (analysis of a relationship between data elements), and displays the result on a relationship diagram.

Further, the present exemplary embodiment defines a directionality of the causal relationship between events, and estimates the causal relationship between pieces of data in a state where the defined causal relationship is fixed, on a relationship diagram created by an operation from the user.

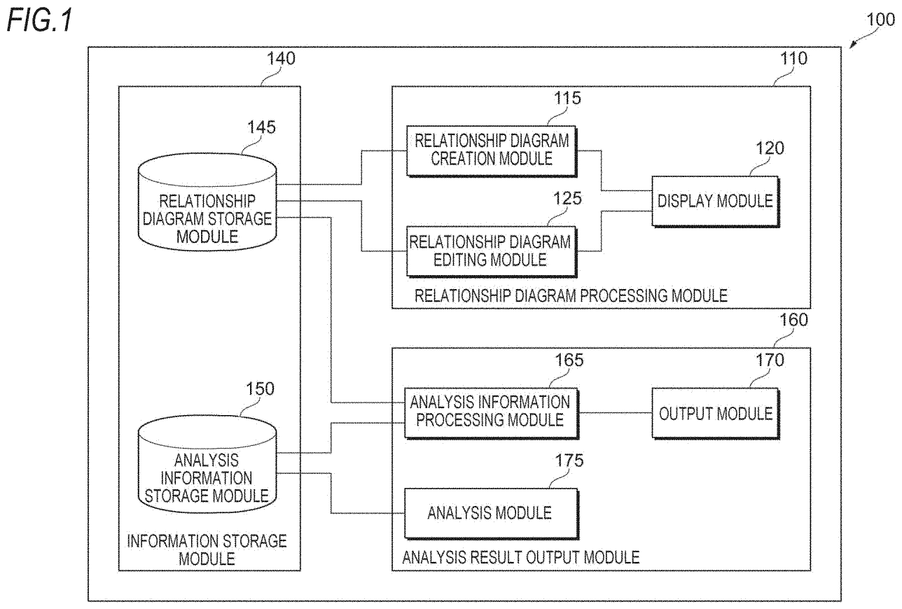

FIG. 1 illustrates a conceptual module configuration diagram illustrating an example of a configuration of the present exemplary embodiment.

A module generally refers to a logically separable component such as software (computer program) or hardware. Accordingly, a module in the present exemplary embodiment indicates not only a module in a computer program but also a module in a hardware configuration. Thus, the present exemplary embodiment also describes a computer program (a program for causing a computer to execute each procedure, a program for causing a computer to function as each unit, or a program for causing a computer to implement each function), a system, and a method which are allowed to serve as these modules. Meanwhile, for the convenience of descriptions, the expressions “store,” “caused to be stored,” and equivalent expressions thereto will be used, and when the present exemplary embodiment is a computer program, the expressions indicate that the computer program is stored or controlled to be stored in a storage device. In addition, one module may correspond to one function. In implementation, however, one module may be configured by one program, multiple modules may be configured by one program, or in reverse, one module may be configured by multiple programs. Further, multiple modules may be executed by one computer, or one module may be executed by multiple computers in a distributed or parallel environment. In addition, one module may include another module. In addition, hereinafter, the term “connection” is used for a case of not only a physical connection but also a logical connection (e.g., data exchange, an instruction, a reference relationship between data, and a login). The term “predetermined” refers to being determined prior to a target processing, and includes the meaning of being determined according to a circumstance/state at or until a specific time point as long as the target processing is not yet performed before a processing according to the present exemplary embodiment is started, or even after the processing according to the present exemplary embodiment is started. When multiple “predetermined values” exist, the values may be different from each other, or two or more of the values (including any values) may be identical to each other. In addition, when items are enumerated like “A, B, and C,” the enumeration is merely exemplary unless otherwise specified, and includes a case where only one (e.g., only A) of the items is selected.

In addition, a configuration of a system or apparatus includes not only a configuration in which, for example, multiple computers, hardware components, and apparatuses are connected to each other via a communication unit such as a network (including a one-to-one corresponding communication connection), but also a configuration implemented with, for example, one computer, hardware component, or apparatus. The terms “apparatus” and “system” are used to have the same meaning. The “system” does not include a system that is merely a social “structure” (social system) which is an artificial engagement.

In addition, in each processing by each module or in each of multiple processings in a case where the multiple processings are performed in the module, target information is read from a storage device, and a processing result is written in the storage device after the processing is performed. Thus, descriptions regarding the reading from the storage device prior to the processing and the writing in the storage device after the processing may be omitted. In addition, examples of the storage device may include a hard disk, a random access memory (RAM), an external storage medium, a storage device via a communication line, and a register within a central processing unit (CPU).

An information processing apparatus 100 according to the present exemplary embodiment displays a relationship diagram, and as illustrated in FIG. 1, the information processing apparatus 100 includes a relationship diagram processing module 110, an information storage module 140, and an analysis result output module 160.

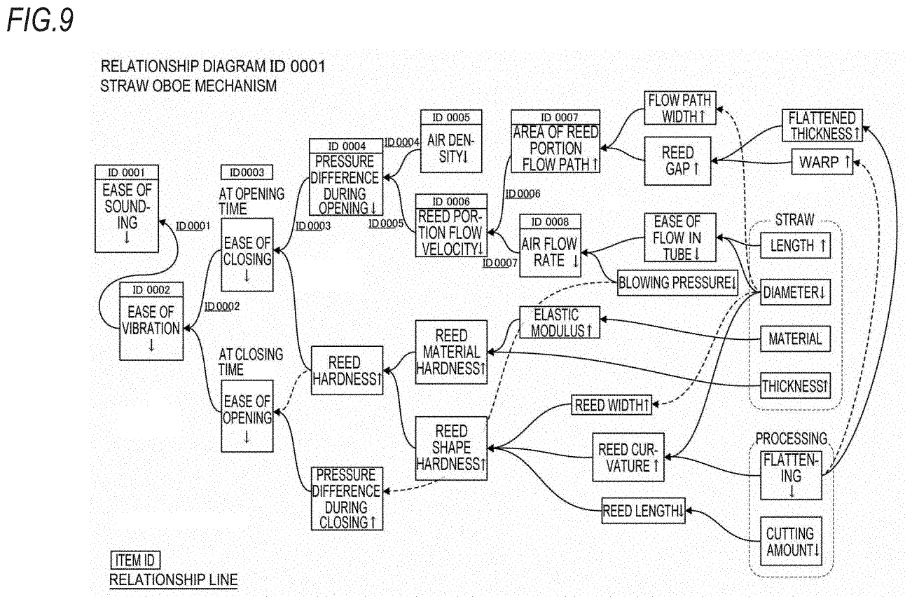

The relationship diagram is a diagram for clarifying the causal relationship under a circumstance where a problem sought to be solved is clear, and causes of the occurrence of the problem are intertwined with each other. As illustrated in FIG. 9, the relationship diagram is constituted with items and relationship lines.

The relationship diagram processing module 110 includes a relationship diagram creation module 115, a display module 120, and a relationship diagram editing module 125. The relationship diagram processing module 110 performs creating, editing, and displaying the relationship diagram.

The relationship diagram creation module 115 is connected to the display module 120 and a relationship diagram storage module 145 of the information storage module 140. The relationship diagram creation module 115 receives information necessary for creating the relationship diagram. For example, the relationship diagram generation module 115 receives information of a relationship diagram, items, and relationship lines which are created according to, for example, an operation of keyboard keys and a mouse by a user, on a user interface displayed on a display device such as a liquid crystal display. In addition to receiving the information from, for example, the operation of keyboard keys and a mouse by the user, the relationship diagram generation module 115 may read information stored in, for example, a hard disk (including, for example, not only a hard disk equipped in a computer but also a hard disk connected via a network).

The display module 120 is connected to the relationship diagram creation module 115 and the relationship diagram editing module 125. The display module 120 displays the relationship diagram created by the relationship diagram creation module 115 or the relationship diagram edited by the relationship diagram editing module 125, on a display device such as a display. Here, in a case where the user performs no further operation on the display, the display module 120 may serve as an output module that, for example, prints the relationship diagram by a printing device such as a printer, transmits an image by an image transmission apparatus such as a facsimile, records the relationship diagram in a storage device such as a database, stores the relationship diagram in a storage medium such as a memory card, or transfers the relationship diagram to another information processing apparatus. In the present exemplary embodiment, the display module 120 is provided as an example of a display unit that displays the relationship diagram.

The relationship diagram editing module 125 is connected to the display module 120 and the relationship diagram storage module 145 of the information storage module 140. The relationship diagram editing module 125 edits the relationship diagram displayed by the display module 120 according to an editing operation to the relationship diagram by the user. For example, the relationship diagram editing module 125 performs editing of an item (including, for example, addition and deletion), editing of an attribute of an item (e.g., name or characteristic of an item), reassignment of a relationship line (including, for example, addition and deletion), and editing of an attribute of a relationship line (e.g., strength or direction), according to the user's editing operation.

The information storage module 140 includes the relationship diagram storage module 145 and an analysis information storage module 150. The information storage module 140 stores information on the relationship diagram and information on an analysis result of actual data corresponding to the relationship diagram (which may be data obtained from a measurement result or data set by the user).

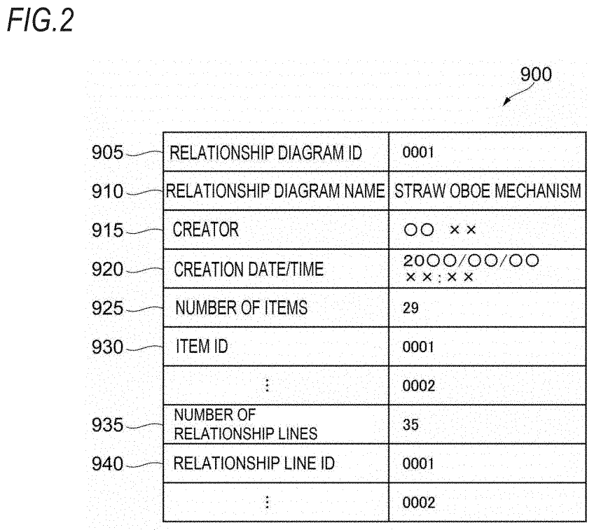

The relationship diagram storage module 145 stores the information of the relationship diagram. As a specific example, a relationship diagram information table 900, an item information table 1000, and a relationship line information table 1100 are stored. FIG. 2 is an explanatory view illustrating an example of a data structure of the relationship diagram information table 900. The relationship diagram information table 900 includes a relationship diagram ID field 905, a relationship diagram name field 910, a creator field 915, a creation date/time field 920, a number of items field 925, an item ID field 930, a number of relationship lines field 935, and a relationship line ID field 940. In the present exemplary embodiment, the relationship diagram ID field 905 stores information for uniquely identifying the relationship diagram (relationship diagram identification (ID)). The relationship diagram name field 910 stores a name of the relationship diagram of the relationship diagram ID. The creator field 915 stores a creator of the relationship diagram. The creation date/time field 920 stores date/time when the relationship diagram is created or edited (year, month, day, hour, minute, second, subsecond, or a combination thereof). The number of items field 925 stores the number of items in the relationship diagram. The item ID field 930 is subsequently continued in accordance with the number of items in the number of items field 925. In the present exemplary embodiment, the item ID field 930 stores information for uniquely identifying an item (item ID). The information indicated by the item ID is stored in the item information table 1000. The number of relationship lines field 935 stores the number of relationship lines in the relationship diagram. The relationship line ID field 940 is subsequently continued in accordance with the number of relationship lines in the number of relationship lines field 935. In the present exemplary embodiment, the relationship line ID field 940 stores information for uniquely identifying a relationship line (relationship line ID). The information indicated by the relationship line ID is stored in the relationship line information table 1100.

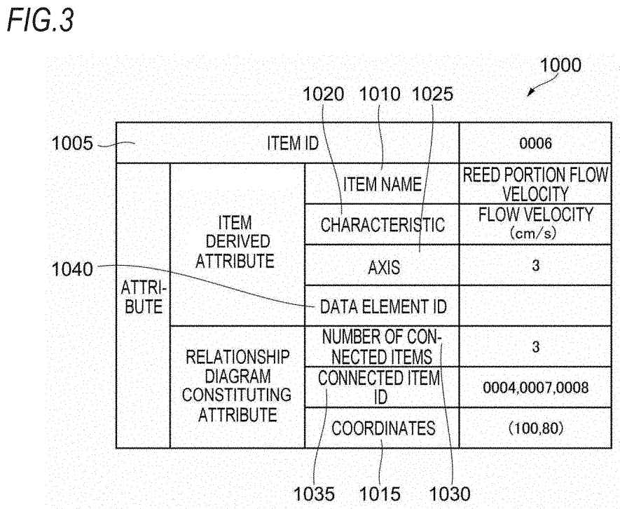

FIG. 3 is an explanatory view illustrating an example of a data structure of the item information table 1000. The item information table 1000 is prepared for each item ID, and includes an item derived attribute which is an attribute incidental to an item and a relationship diagram constituting attribute which is an attribute for constructing the relationship diagram, as attributes. The item derived attribute includes attributes such as an item name, an item characteristic, and an axis to which an item belongs. Here, the characteristic refers to a property, a behavior, or an action. The relationship diagram constituting attribute includes attributes such as the number of connected items, connected item ID, and coordinates. According to these attributes, the item information table 1000 includes an item ID field 1005, an item name field 1010, a coordinate field 1015, a characteristic field 1020, an axis field 1025, a number of connected items field 1030, and a connected item ID field 1035. The item ID field 1005 stores an item ID. The item name field 1010 stores a name of the item of the item ID. The coordinate field 1015 stores coordinates of the item on the relationship diagram where the item is displayed. The characteristic field 1020 stores a characteristic of the item. The axis field 1025 stores an axis to which an axis item corresponding to the item belongs, when the relationship diagram is converted into a deployment diagram. The number of connected items field 1030 stores the number of items to which the item is connected, that is, the sum of the number of connection destination items when the item is a connection source item and the number of connection source items when the item is a connection destination item. The connected item ID field 1035 is subsequently continued in accordance with the number of items in the number of connected items field 1030. The connected item ID field 1035 stores a connection destination item ID and a connection source item ID. For example, in a case of a reed portion flow velocity, the item information table 1000 shows the item ID “0006.” the item name “reed portion flow velocity,” the characteristic “flow velocity (cms),” the axis “3,” the number of connected items “3,” the connected item ID “0004, 0007, 0008,” and the coordinates “(100, 80).”

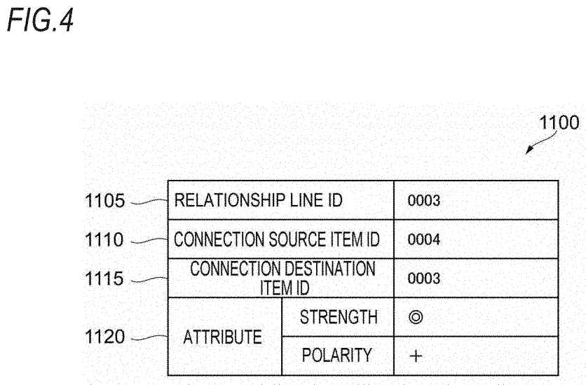

FIG. 4 is an explanatory view illustrating an example of a data structure of the relationship line information table 1100. The relationship line information table 1100 includes a relationship line ID field 1105, a connection source item ID field 1110, a connection destination item ID field 1115, and an attribute field 1120. The relationship line ID field 1105 stores a relationship line ID. The connection source item ID field 1110 stores an item ID of an item which is a connection source of the relationship line. The connection destination item ID field 1115 stores an item ID of an item which is a connection destination of the relationship line. The attribute field 1120 stores an attribute of the relationship line. The attribute is, for example, a polarity of the relationship line. For example, the polarity refers to a property of the relationship line which is in the relation that when a numerical value of an item which is a connection source increases, a numerical value of an item which is a connection destination also increases (e.g., a direct proportion), or when the numerical value of the item which is the connection source increases, the numeral value of the item which is the connection destination decreases (e.g., an inverse proportion). The attribute may be, for example, the strength of the relevance of the relationship line or the direction of the relationship.

FIGS. 2 to 4 are merely exemplary, and other data structures may be used. For example, a data structure indicating a graph structure may be used.

The analysis information storage module 150 stores information on an analysis result of actual data corresponding to the relationship diagram. The actual data is, for example, data acquired in each processing from designing a product which is an analysis target in the relationship diagram until manufacturing the product and checking the quality. As a specific example, an element analysis information table 1200 and a relationship analysis information table 1300 are stored.

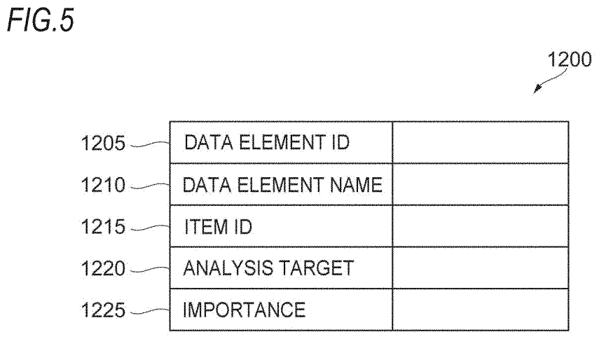

FIG. 5 is an explanatory view illustrating an example of a data structure of the element analysis information table 1200. The element analysis information table 1200 includes a data element ID field 1205, a data element name field 1210, an item ID field 1215, an analysis target field 1220, and an importance field 1225. The data element ID field 1205 stores a data element ID. The data element name field 1210 stores a name of the data element of the data element ID. The item ID field 1215 stores an item ID of an item constructing the relationship diagram and associated with the data element. The analysis target field 1220 stores a data element ID of a data element which is the target of the analysis of data elements. The importance field 1225 stores an importance (contribution degree), obtained by the analysis of data elements, with respect to the data element which is the target of the analysis of data elements.

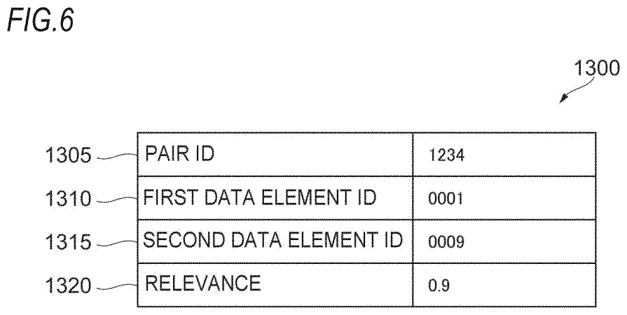

FIG. 6 is an explanatory view illustrating an example of a data structure of the relationship analysis information table 1300. The relationship analysis information table 1300 includes a pair ID field 1305, a first data element ID field 1310, a second data element ID field 1315, and a relevance field 1320. The pair ID field 1305 stores information for uniquely identifying a pair of data elements (pair ID). The first data element ID field 1310 stores a data element ID of one (first data element) of the two data elements included in the pair of data elements. The second data element ID field 1315 stores a data element ID of the other (second data element) of the two data elements included in the pair of data elements. The relevance field 1320 stores the relevance between the two data elements included in the pair of data elements.

FIGS. 5 and 6 are exemplary, and other data structures may be used. For example, a data structure indicating a graph structure may be used.

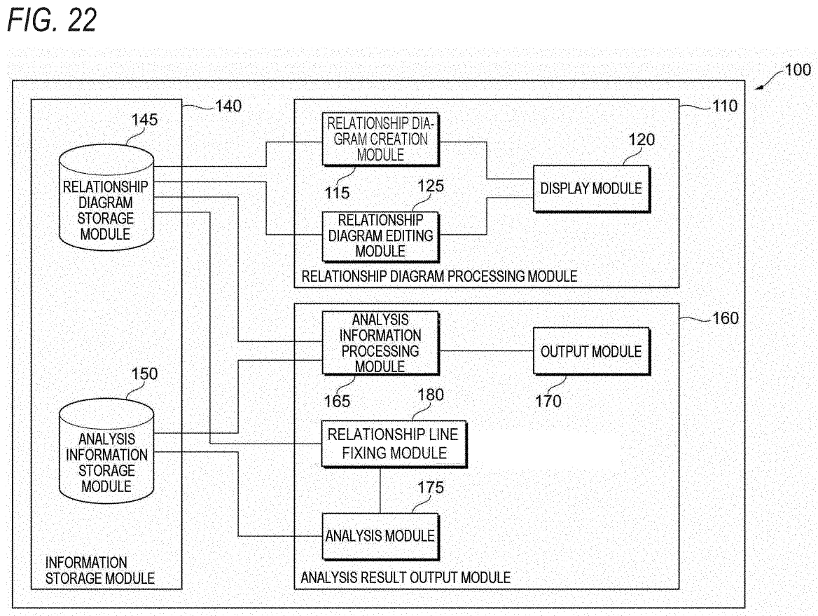

The analysis result output module 160 includes an analysis information processing module 165, an output module 170, and an analysis module 175. As illustrated in FIG. 22, the analysis result output module 160 may further include a relationship fixing module 180. The analysis result output module 160 outputs the analysis result of the actual data corresponding to the relationship diagram, on the relationship diagram. For example, according to an analysis instruction operation by the user, the analysis module 170 performs an analysis of data elements corresponding to items of the relationship diagram (analysis of data elements), or an analysis of a relationship between data elements corresponding to items of the relationship diagram or a relationship between data elements including a data element which corresponds to an item of the relationship diagram and a data element which does not correspond to an item of the relationship diagram (analysis of a relationship between data elements), and according to an output instruction operation by the user, the analysis result output module 160 outputs a display element indicating the analysis result on the relationship diagram.

The analysis information processing module 165 is connected to the output module 170, and the relationship diagram storage module 145 and the analysis information storage module 150 of the information storage module 140. The analysis information processing module 165 associates a data element which is actual data corresponding to an item of the relationship diagram, with the item, and stores the association information in the item information table 1000 of the relationship diagram storage module 145 and the element analysis information table 1200 of the analysis information storage module 150. In the present exemplary embodiment, the analysis information processing module 165 is provided as an example of an association unit that associates data with an item. In addition, the analysis information processing module 165 extracts the result of the analysis of data elements or the analysis of a relationship between data elements, by using the item information table 1000 and the relationship line information table 1100 of the relationship diagram storage module 145, and the element analysis information table 1200 and the relationship analysis information table 1300 of the analysis information storage module 150.

The output module 170 is connected to the analysis information processing module 165. The output module 170 outputs a display element indicating the analysis result extracted by the analysis information processing module 165, on the relationship diagram. Here, the outputting of the display element includes, for example, displaying the display element on a display device such as a display, printing the display element by a printing device such as a printer, transmitting an image by an image transmission device such as a facsimile, writing the display element in a storage device such as a database, storing the display element in a storage medium such as a memory card, and transferring the display element to another information processing apparatus. In the present exemplary embodiment, the output module 170 is provided as an example of an output unit that outputs the display element in such a way that the display element is displayed on the relationship diagram. In addition, the output module 170 may be provided as an example of an output unit that outputs the display element in such a way that the display element is displayed on the relationship diagram without causing inconsistency with a specific relationship line.

According to the user's analysis instruction operation, the analysis module 175 performs the analysis of data elements or the analysis of a relationship between data elements using a designated analysis method. In the present exemplary embodiment, an analysis of a directionality of a relationship may be performed as the analysis of a relationship between data elements. However, without being limited to the directionality of the relationship, other general attributes of the relationship may be analyzed.

Here, as for the analysis method, when the analysis of data elements is performed, for example, a multiple regression analysis may be used, and when the analysis of a relationship between data elements is performed, for example, a partial correlation analysis may be used. When the analysis of a directionality of a relationship is performed as the analysis of a relationship between data elements, for example, a covariance structure analysis may be used, and when the analysis of a directionality of a relationship is not performed as the analysis of a relationship between data elements, for example, the partial correlation analysis may be used.

According to the user's analysis instruction operation along with designation of a directionality of a relationship line between items, the relationship fixing module 180 fixes the designated directionality of the relationship line when the analysis module 175 performs the analysis of a relationship between data elements. However, without being limited to the directionality of the relationship line, other general attributes of the relationship line may be fixed. In the present exemplary embodiment, the relationship fixing module 180 is provided as an example of a receiving unit that receives designation of a specific relationship line between multiple items.

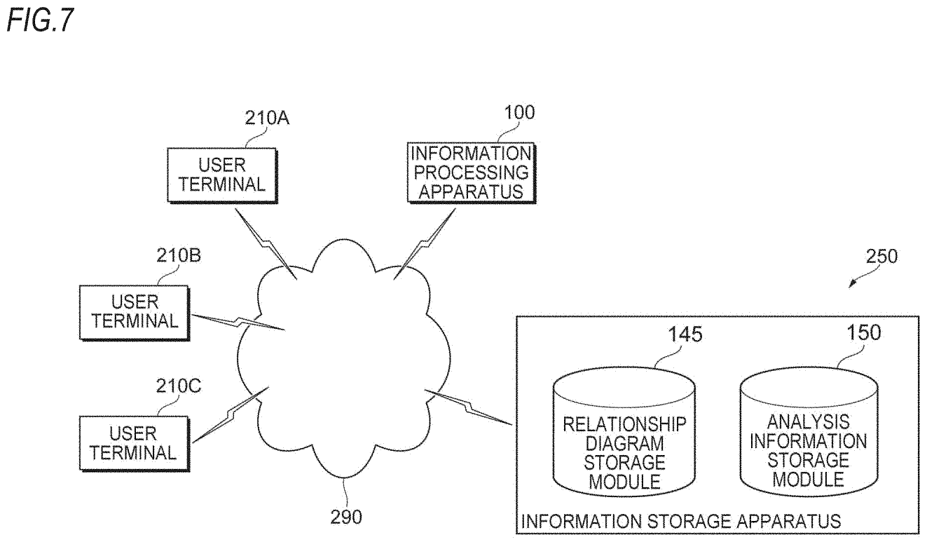

FIG. 7 is an explanatory view illustrating an example of a system configuration using the present exemplary embodiment;

The information processing apparatus 100, user terminals 210A, 210B, and 210C, and an information storage apparatus 250 are connected to each other via a communication line 290. The communication line 290 may be a wireless communication line, a wired communication line, or a combination thereof, and may be, for example, the Internet or an intranet as a communication infrastructure. In addition, the functions of the information processing apparatus 100 and the information storage apparatus 250 may be implemented by a cloud service. The information storage apparatus 250 includes a relationship diagram storage module 145 and an analysis information storage module 150, and the information processing apparatus 100 may use the relationship diagram storage module 145 and the analysis information storage module 150 in the information storage apparatus 250 via the communication circuit 290, as the above-described relationship diagram storage module 145 and analysis information storage module 150.

For example, in the information processing apparatus 100, the relationship diagram is created according to the user's operation in the user terminal 210A. The information of the relationship diagram is stored in the relationship diagram storage module 145 of the information storage apparatus 250 via the communication line 290.

For example, the user of the user terminal 210B mainly analyzes the relationship between data elements corresponding to items of the relationship diagram, and the information of the analysis result is stored in the information storage module 150 of the information storage apparatus 250 via the communication line 290.

For example, in the information processing apparatus 100, a display element indicating the analysis result is output on the relationship diagram according to the user's operation in the user terminal 210A.

In addition, the information processing apparatus 100 may be equipped in the user terminal 210. In that case, a stand-alone type system is formed.

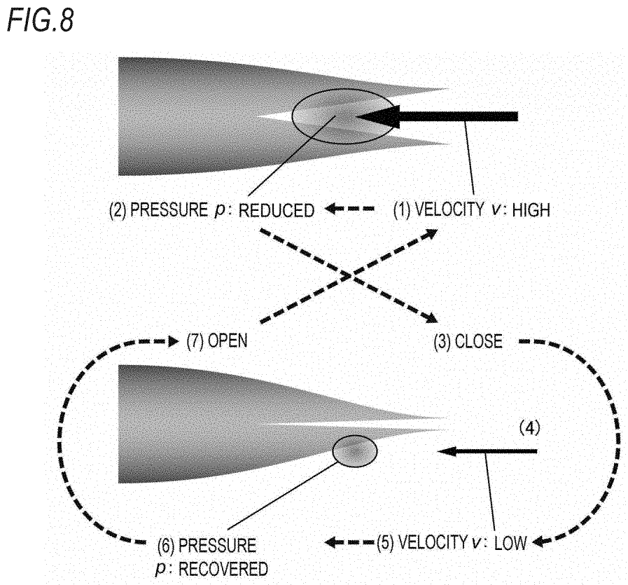

Next, descriptions will be made on an example where, with regard to the straw oboe mechanism, the relationship diagram is created, and the deployment table is generated, using FIGS. 8 to 12.

FIG. 8 is an explanatory view of an example of the technique which is the target of the relationship diagram and the deployment table (the straw oboe mechanism).

This technique uses the rule of hydraulic engineering which refers to the Bernoulli's theorem (see Equation 1) providing that “when the flow velocity increases, the pressure decreases.”

(Equation 1)

p+½ρv²=CONSTANT(p:PRESSURE r:DENSITY,v:VELOCITY) (1)

The matter of “why does the vibration occur?” may be explained as follows. The numbers in parentheses correspond to the numbers in parentheses of FIG. 8.

(1) When blowing through the straw, the flow velocity inside the straw becomes high.

(2) When the flow velocity becomes high, the pressure decreases.

(3) When the pressure decreases, the reed is drawn inward.

(4) When the reed is drawn inward, the flow path becomes narrow.

(5) When the flow path becomes narrow, the flow velocity becomes low.

(6) When the flow velocity becomes low, the pressure is recovered.

(7) When the pressure is recovered, the reed is opened. This flow is returned to (1).

FIG. 9 is an explanatory view illustrating an example of a relationship diagram; FIG. 9 illustrates an example of the relationship diagram of the mechanism where the straw oboe does not sound. This relationship diagram is created by the relationship diagram creation module 115 according to the user's operation.

In addition, it is promised that the “density of air is unchanged” and a “flattening processing method is undetermined.”

In the example of FIG. 9, the respective items surrounded by rectangles are connected together with relationship lines. Further, in each item, the upward arrow indicates an increase of the item, and the downward arrow indicates a decrease of the item.

In addition, the color of each relationship line between items indicates the polarity of the causal relationship. The solid line connecting items together indicates a positive correlation, and the dashed line connecting items together indicates a negative correlation. For example, it is indicated that when the item “ease of vibration” decreases, the item “ease of sounding” also decreases. In addition, the strength of the influence of the causal relationship may be indicated by, for example, the thickness of a line. These pieces of information are stored in the attribute field 1120 of the relationship line information table 1100.

In FIG. 9, the item ID and the relationship line ID are displayed on the relationship diagram. However, the item ID and the relationship line ID may not be displayed on the relationship diagram actually displayed on a screen.

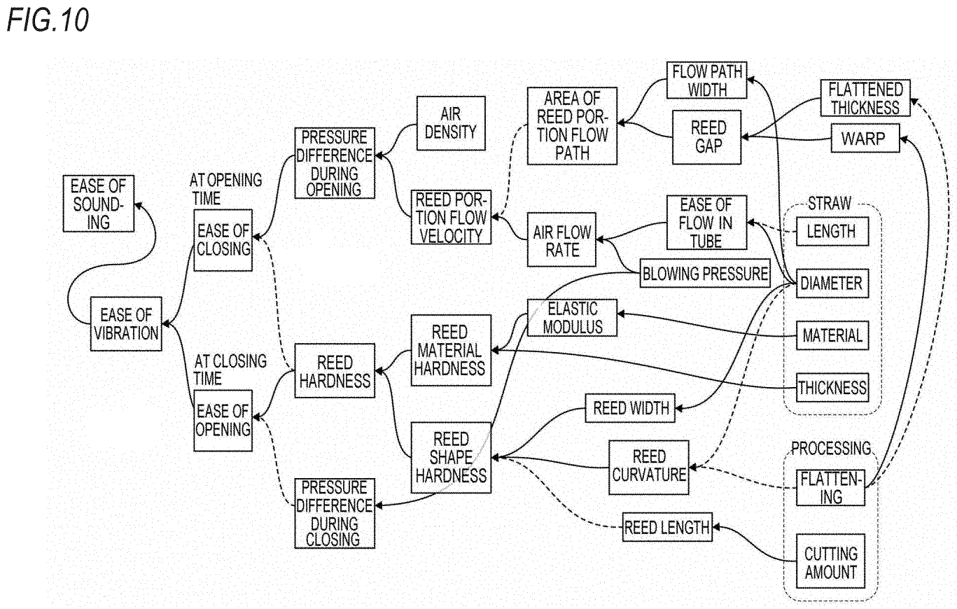

FIG. 10 is an explanatory view illustrating an example of a relationship diagram; In this relationship diagram, the respective items in the relationship diagram illustrated in the example of FIG. 9 are unified into causes of an increase. That is, FIG. 10 illustrates an example of the relationship diagram of the ease of sounding. Accordingly, there are a relationship line between items of which the positive correlation becomes the negative correlation, and inversely, a relationship line between items of which the negative correlation becomes the positive correlation.

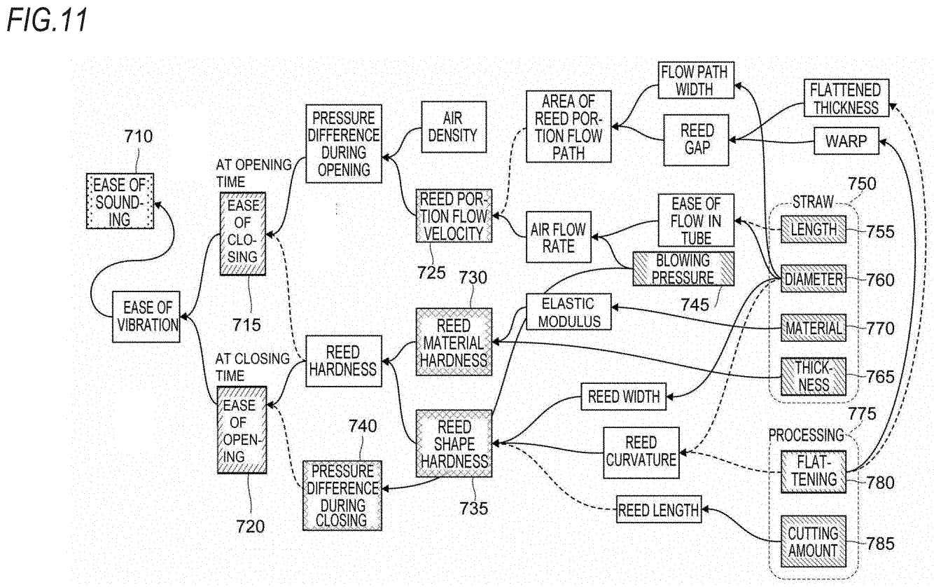

FIG. 11 is an explanatory view illustrating an example of a relationship diagram;

FIG. 11 illustrates an example where items to be adopted as axes (axis items) of the deployment table are selected by the user's operation. Here, FIG. 11 shows that a first axis is a quality, a second axis is a function, a third axis is a physical quantity, and a fourth axis is a design.

An item (ease of sounding) 710 is selected as the first axis.

An item (ease of closing at the opening time) 715 and an item (ease of opening at the closing time) 720 are selected as the second axis.

An item (reed portion flow velocity) 725, an item (reed material hardness) 730, an item (reed shape hardness) 735, and an item (pressure difference during closing) 740 are selected as the third axis.

An item (blowing pressure) 745, an item (length) 755, an item (diameter) 760, an item (thickness) 765, an item (material) 770, an item (flattening) 780, and an item (cutting amount) 785 are selected as the fourth axis.

The information of the selected axes is stored in the axis field 1025 of the item information table 1000.

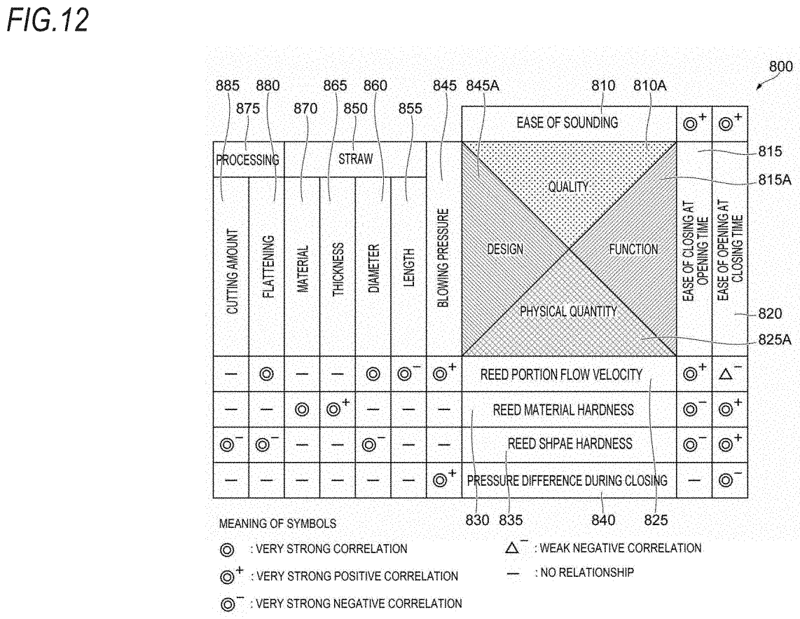

FIG. 12 is an explanatory view illustrating an example of a deployment table; FIG. 12 illustrates the deployment table generated from the relationship diagram illustrated in the example of FIG. 11. That is, FIG. 12 shows an example of the deployment table for the ease of sounding of the straw oboe.

The target of the deployment table is the entire system to be developed/designed or a portion thereof.

A first axis (quality) 810A is the quality and is an index of the value guaranteed to a customer. Further, the first axis (quality) 810A is an index of the value obtained when the system (component) which is the target of the deployment table exhibits its function, and is an index of the value guaranteed to a customer by the system or its host system. The first axis (quality) 810A has an axis item (ease of sounding) 810.

A second axis (function) 815A is the role performed by the component of the system or the partial system in order to achieve the quality. The second axis (function) 815A has an axis item (ease of closing at the opening time) 815 and an axis item (ease of opening at the closing time) 820.

A third axis (physical quantity) 825A is a physical quantity that determines the function exhibited by the component of the system or the partial system. The third axis (physical quantity) 825A has an axis item (reed portion flow velocity) 825, an axis item (reed material hardness) 830, an axis item (reed shape hardness) 835, and an axis item (pressure difference during closing) 840.

The fourth axis (design) 845A is a setting condition for controlling the physical quantity of the component of the target or the partial system, and is an amount and a condition that may (or need to) be determined by a designer or a developer. The fourth axis (design) 845A has an axis item (blowing pressure) 845, an axis item (straw) 850, and an axis item (processing) 875. The axis item (straw) 850 has an axis item (length) 855, an axis item (diameter) 860, an axis item (thickness) 865, and an axis item (material) 870. The axis item (processing) 875 has an axis item (flattening) 880 and an axis item (cutting amount) 885.

The inside of a cell positioned between adjacent axis items in the deployment table (the rectangle in which, for example, the symbol ⊚, which means very strong correlation, is present in the example of FIG. 12) indicates the information of the causal relationship. The information of the causal relationship indicates the causal relationship between two axis items. The symbols “⊚,” “∘,” and “Δ” indicate the strength of the influence of the causal relationship, and mean “very strong correlation,” “strong correlation,” and “weak correlation,” respectively. The symbols “+” and “−” annexed thereto indicate the polarity of the causal relationship, and mean “positive correlation” and “negative correlation.” respectively. That is, positive correlation is indicated by “+,” negative correlation is indicated by “−,” strong positive correlation is indicated by “⊚+,” weak positive correlation is indicated by “Δ+,” strong negative correlation is indicated by “⊚−,” weak negative correlation is indicated by “Δ−,” and “−” indicates no relationship. For example, the relationship between the axis item (ease of sounding) 810 and the axis item (ease of closing at the opening time) 815 is “⊚+” (very strong positive correlation). These pieces of information reflect the attributes stored in the attribute field 1120 of the relationship line information table 1100.

First, descriptions will be made on a processing of associating a data element with an item of the relationship diagram.

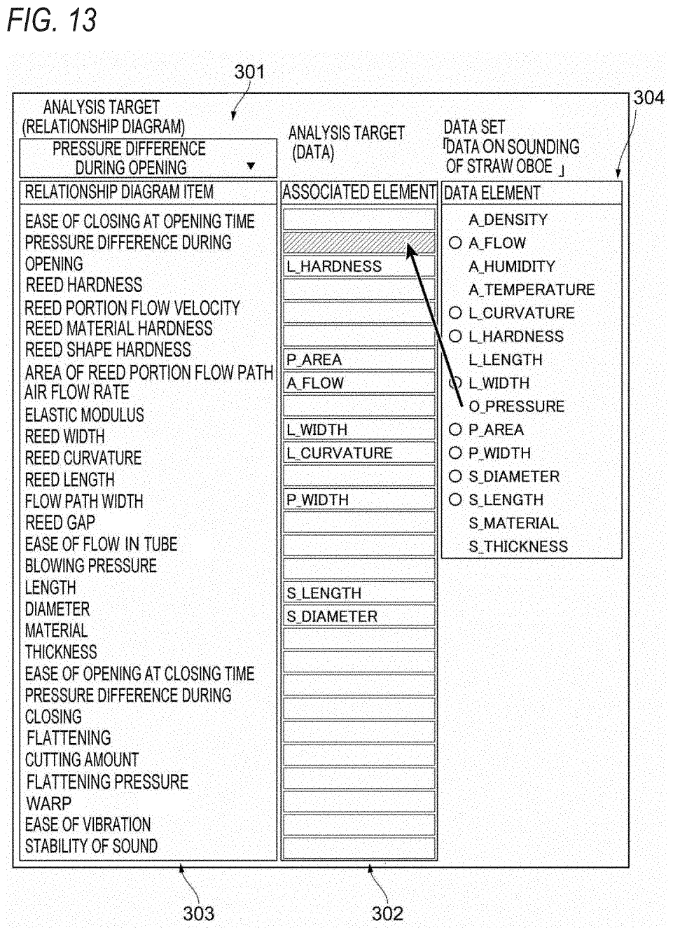

FIG. 13 is an explanatory view illustrating an example of a screen:

In a selection area 301, the item “pressure difference during opening” is selected as the analysis target in the relationship diagram.

An operation area 302 displays a data element associated as an analysis target in the actual data corresponding to the relationship diagram, with an item of the relationship diagram, and is provided to function as an area for performing the processing of associating a data element with an item of the relationship diagram.

A display area 303 displays multiple items in the relationship diagram.

A display area 304 displays multiple data elements read from data sets acquired as operation data of an actual system or measurement data of an article.

In this state, it is assumed that the user performs an operation to select an arbitrary data element from the multiple data elements displayed in the display area 304, and drag the selected data element to a position in the operation area 302 which corresponds to an arbitrary item of the multiple items displayed in the display area 303 (e.g., a row in the operation area 302 which is the same as the row of the arbitrary item). Then, the data element selected from the multiple data elements is associated with the item displayed in the position in the display area 303 which corresponds to the position of the drag destination in the operation area 302, among the multiple items displayed in the display area 303. For example, the data element “O_PRESSURE” is dragged to the hatched portion of the operation area 302 so as to be associated with the item “pressure difference during opening.” In addition, among the multiple data elements displayed in the display area 304, a data element that has already been associated with any one of the items displayed in the display area 303 is annexed with the mark “∘” indicating the associated state.

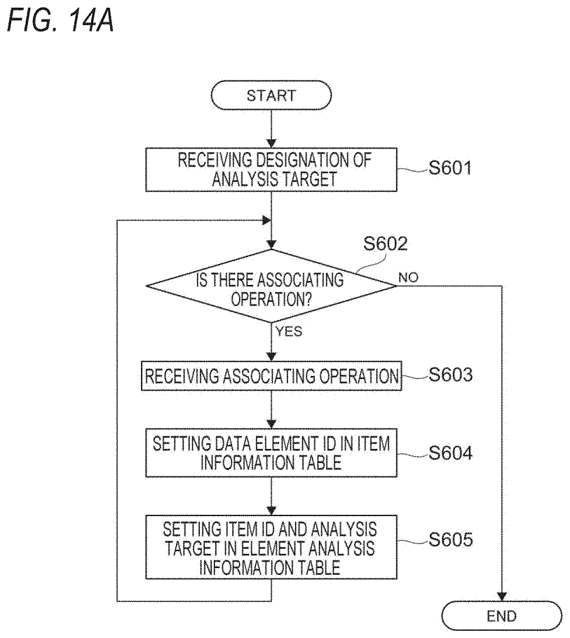

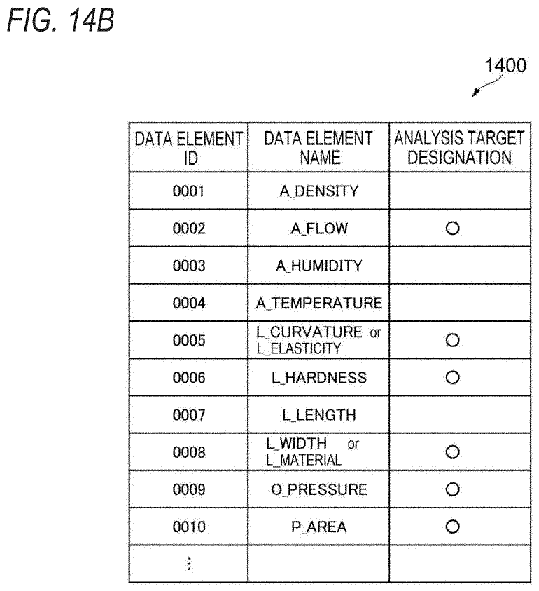

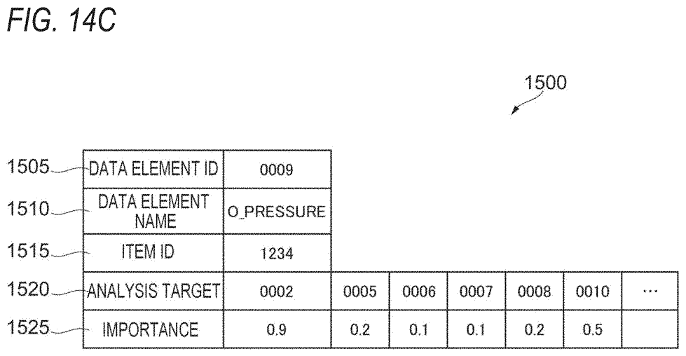

FIG. 14A is a flowchart illustrating an example of a processing according to the present exemplary embodiment:

In the information processing apparatus 100, first, the analysis information processing module 165 receives designation of the analysis target (step S601). In the example of the screen of FIG. 13, the item ID of the item selected in the selection area 301 is received.

Subsequently, the analysis information processing module 165 determines whether the user has performed an associating operation to associate an arbitrary data element with an arbitrary item (step S602). When it is determined that the user has performed the associating operation, the analysis information processing module 165 receives the associating operation (step S603). In the example of the screen of FIG. 13, the analysis information processing module 165 receives the data element ID of the data element dragged to the operation area 302, among the multiple data elements displayed in the display area 304, and the item ID of the item displayed at the position in the display area 303 which corresponds to the position in the operation area 302 to which the data element has been dragged, among the multiple items displayed in the display area 303. For example, the data element ID of the data element “L_HARDNESS” is received as the data element ID of the data element dragged to the operation area 302, and the item ID of the item “reed hardness” is received as the item ID displayed at the position in the display area 303 which corresponds to the position in the operation area 302 to which the data element has been dragged.

Accordingly, the analysis information processing module 165 reads the item information table 1000 for the item which is the target of the associating operation received in step S603, from the relationship diagram storage module 145, and sets the data element ID of the data element which is the target of the associating operation received in step S603, in the data element ID field 1040 (step S604). For example, the data element ID “0009” of the data element “O_PRESSURE” which is the target of the associating operation received in step S603 for the item “pressure difference during opening” is set.

Further, the analysis information processing module 165 reads the element analysis information table 1200 for the data element which is the target of the associating operation received in step S603, from the analysis information storage module 150. Then, the analysis information processing module 165 sets the item ID of the item which is the target of the associating operation received in step S602, in the item ID field 1215, and sets the data element ID of the data element which is the analysis target received in step S601, in the analysis target field 1220 (step S605).

At this time, descriptions will be made on the flow of setting the data in the element analysis information table 1200, using FIGS. 14B and 14C. A data set table 1400 illustrated in FIG. 14B shows data forms of the data element set displayed in the display area 304 of FIG. 13. Data element IDs “0001,” “0002,” . . . are allocated to the data elements “A_DENSITY,” “A_FLOW,” . . . , respectively. Further, the data element associated with the item in step S603 is annexed with the symbol “∘” indicating that the data element has been designated as the analysis target. In step S605, the element analysis information table 1200 for the data element “O_PRESSURE” associated with the item “pressure difference during opening” selected as the analysis target item is read, and by referring to the data set table 1400, “O_PRESSURE” is set in the data element name, “0009” is set in the data element ID, and the item ID “1234” assigned to the associated item “pressure difference during opening” is set. Further, as analysis target data elements, by referring to the data set table 1400, “0002,” “0005,” “0006,” . . . which are the IDs of the data elements assigned with the symbol “∘” are set. In the element analysis information table 1500 illustrated in FIG. 14C, a data element ID 1505, a data element name 1510, an item ID 1515, and an analysis target 1520 are set. Here, since the analysis processing has not been performed, an importance 1525 is not set.

Then, the analysis information processing module 165 returns the processing to step S602, and when it is determined that the user has not performed the associating operation, the processing is ended.

Next, descriptions will be made on a processing of outputting the result of the analysis of data elements performed on the data elements associated with the items, on the relationship diagram.

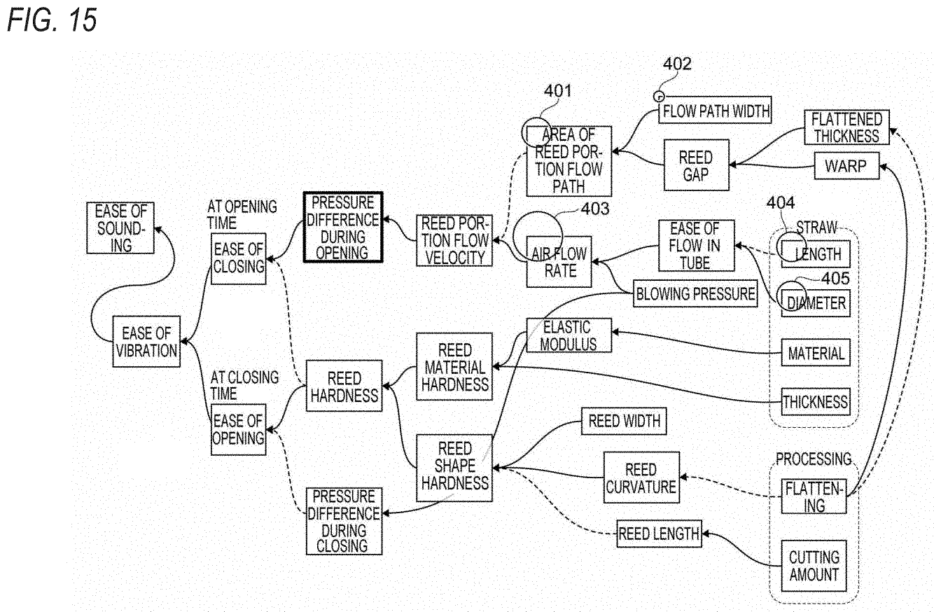

FIG. 15 is an explanatory view illustrating an example of a processing on a relationship diagram according to the present exemplary embodiment;

In FIG. 15, the item “pressure difference during opening” (data element “O_PRESSURE”) has been selected as the analysis target, as illustrated in FIG. 13 (the item “pressure difference during opening” is indicated to be surrounded by a thick line in FIG. 15). Further, it is assumed that the associating operation illustrated in FIG. 13 has been performed.

In this state, the analysis of data elements is performed. As for an analysis target with respect to the analysis target data element “O_PRESSURE,” the analysis target 1520 of the element analysis information table 1500 illustrated in FIG. 14C is referred to, and an arithmetic processing of calculating a correlation between the data element “O_PRESSURE” and the analysis target data element is performed. Here, it is indicated that a correlation value between the data element “O_PRESSURE” and the data element “A_FLOW” having the data element ID “0002” is calculated so that the value “0.9” is obtained. The correlation value may be calculated in the range of 0 to 1 or may be calculated between −1 and +1. This value may be regarded as the importance. In addition, the analysis target data element may be only the data element annexed with the symbol “c” in the “analysis target designation” field of the data set table 1400 or may be all of the data elements existing in the data set table 1400. A display element is displayed for an item with which the data element having the relatively high importance (contribution degree) with respect to the analysis target data element “O_PRESSURE” is associated. At that time, the display element displayed for an arbitrary item may be indicated in a different form (e.g., different shape, color or transparency) from the item, and may be indicated in a form according to the importance (contribution degree) of the data element associated with the item with respect to the analysis target data element.

For example, the display element may be displayed by a bubble-shaped figure (bubble object) having a size according to the importance (contribution degree). In FIG. 15, a bubble object 403 is displayed to be superimposed on the item “flow rate of air” with which the data element “A_FLOW” having the relatively high value “0.9” indicating the importance with respect to the data element “O_PRESSURE” is associated. For example, when a data element of which the value indicating the importance is equal to or larger than a predetermined value (e.g., 0.5) is a display target, an item with which a data element having an importance equal to or larger than “0.5” is associated is extracted as a display target in the element analysis information table 1500. The ID of the analysis target data element having the importance “0.9” is “0002.” and the element analysis information table 1500 in which the data element ID is “0002” is referred to. By referring to the “item ID” of the element analysis information table in which the data element ID is “0002,” the item information table 1000 corresponding to the item ID is read. By referring to the read item information table 1000, the item “flow rate of air” with which the data element “A_FLOW” having the relatively high value “0.9” indicating the importance with respect to the data element “O_PRESSURE” is associated is specified, and the bubble object 403 is displayed to be superimposed on the item “flow rate of air.” Likewise, a bubble object 401 is displayed to be superimposed on an item “area of reed portion flow path” with which a data element “P_AREA” having a relatively high value indicating the importance with respect to the data element “O_PRESSURE” is associated, a bubble object 402 is displayed to be superimposed on an item “flow path width” with which a data element “P_WIDTH” is associated, a bubble object 404 is displayed to be superimposed on an item “length” with which a data element “S_LENGTH” is associated, and a bubble object 405 is displayed to be superimposed on an item “diameter” with which a data element “S_DIAMETER” is associated. Among the bubble objects 401 to 405, the bubble object 403 is the largest, the bubble objects 401, 404, and 405 are the second largest, and the bubble object 402 is the smallest. This is because the data element “A_FLOW” has the highest importance (contribution degree) with respect to the data element “O_PRESSURE,” the data elements “P_AREA,” “S_LENGTH,” and “S_DIAMETER” have the second highest importance, and the data element “P_WIDTH” exhibits the lowest importance.

In this example, the item “pressure difference during opening” is an example of a first item, and the data element “O_PRESSURE” is an example of first data associated with the first item. In addition, when the item “area of reed portion flow path” is an example of a second item, the data element “P_AREA” is an example of second data associated with the second item, and the bubble object 401 is an example of the display element indicating the second data relevant to the first data or the display element indicating the importance of the second data with respect to the first data. When the item “flow path width” is an example of the second item, the data element “P_WIDTH” is an example of the second data associated with the second item, and the bubble object 402 is an example of the display element indicating the second data relevant to the first data or the display element indicating the importance of the second data with respect to the first data. When the item “flow rate of air” is an example of the second item, the data element “A_FLOW” is an example of the second data associated with the second item, and the bubble object 403 is an example of the display element indicating the second data relevant to the first data or the display element indicating the importance of the second data with respect to the first data. When the item “length” is an example of the second item, the data element “S_LENGTH” is an example of the second data associated with the second item, and the bubble object 404 is an example of the display element indicating the second data relevant to the first data or the display element indicating the importance of the second data with respect to the first data. When the item “diameter” is an example of the second item, the data element “S_DIAMETER” is an example of the second data associated with the second item, and the bubble object 405 is an example of the display element indicating the second data relevant to the first data or the display element indicating the importance of the second data with respect to the first data. Here, while the bubble objects are displayed to be superimposed on items, the display of the bubble objects is not limited thereto. The bubble objects may be displayed in association with items.

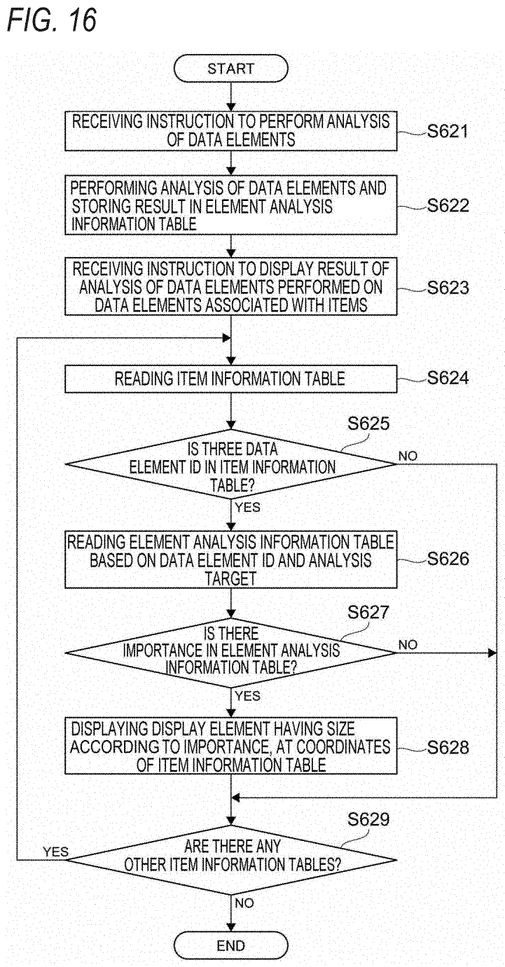

FIG. 16 is a flowchart illustrating an example of a processing according to the present exemplary embodiment;

In the information processing apparatus 100, first, the analysis module 175 receives an instruction to perform the analysis of data elements (step S621). At that time, the instruction to perform the analysis of data elements includes designation of the analysis target data element as well.

Accordingly, the analysis module 175 performs the analysis of data elements instructed in step S621, and stores the result in the element analysis information table 1200 (step S622). For example, for each data element, the element analysis information table 1200 for the data element is read from the analysis information storage module 150, the data element ID of the analysis target data element is set in the analysis target field 1220, and the importance of the data element with respect to the analysis target data element is set in the importance field 1225.

Subsequently, the analysis information processing module 165 receives an instruction to display the result of the analysis of data elements performed on the data elements associated with the items (step S623). At that time, the instruction to display the result of the analysis of data elements includes designation of the analysis target item as well.

Accordingly, the analysis information processing module 165 reads the item information table 1000 for an arbitrary item from the relationship diagram storage module 145 (step S624). For example, one item ID is selected in an order of an item ID, and the item information table 1000 corresponding to the item ID is read.

Subsequently, the analysis information processing module 165 determines whether a data element ID has been set in the data element ID field 1040 of the item information table 1000 read in step S624 (step S625). When it is determined that a data element ID has been set in the data element ID field 1040, a data element has been associated with the item, and thus, the analysis information processing module 165 reads the element analysis information table 1200 based on the data element ID and the analysis target included in the instruction to display the result of the analysis of data elements (step S626).

Subsequently, the analysis information processing module 165 determines whether the importance has been set in the importance field 1225 of the element analysis information table 1200 read in step S626 (step S627). When the analysis of data elements in steps S621 and S622 and the display of the result of the analysis of data elements in steps S623 to S629 are performed in series, the importance has been set in the importance field 1225 of the element analysis information table 1200. Thus, in this case, the determination in step S627 does not need to be performed. However, since the analysis of data elements in steps S621 and S622 and the display of the result of the analysis of data elements in steps S623 to S629 may be performed with a time interval or may be performed by different user terminals (e.g., 210A and 210B), the determination in step S627 is performed. When it is determined that the importance has been set in the importance field 1225 of the element analysis information table 1200, the output module 170 displays the display element having the size according to the importance at the coordinates set in the coordinate field 1015 of the item information table 1000 read in step S624 (step S628). Here, the description “displaying the display element at the coordinates” means displaying the display element at a position related to the coordinates. That is, it is not required to display the display element to the extent that the center of the display element exactly coincides with the coordinates, and for example, the display element may be displayed to the extent that an overlapping portion exists between the figure indicating the item and the display element.

In addition, when it is determined in step S625 that the data element ID has not been set in the data element ID field 1040 or when it is determined in step S627 that the importance has not been set in the importance field 1225 of the element analysis information table 1200, the output module 170 does not display the display element, and the processing proceeds to step S629.

Then, the analysis information processing module 165 determines whether there exist any other item information tables 1000 that have not been read (step S629). When the analysis information processing module 165 determines that there exist other item information tables 1000 that have not been read, the processing returns to step S624, and when the analysis information processing module 165 determines that there exist no other item information tables 1000 that have not been read, the processing is ended.

Next, descriptions will be made on a processing of outputting the result of the analysis of a relationship between data elements, on the relationship diagram.

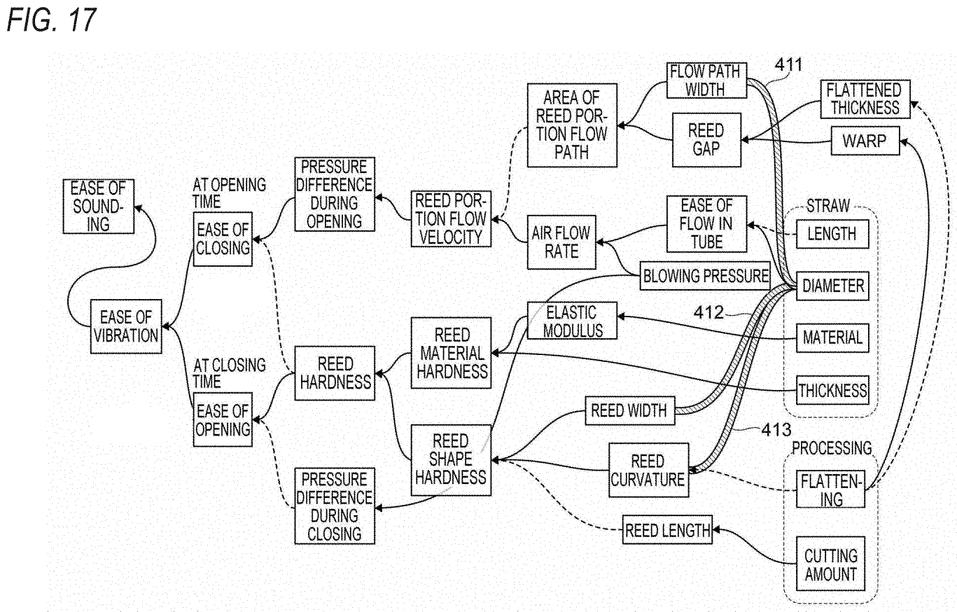

FIG. 17 is an explanatory diagram illustrating an example of a processing on the relationship diagram according to the present exemplary embodiment.

In FIG. 17, it is assumed that the associating operation illustrated in FIG. 13 has been performed as well.

In this state, the analysis of a relationship between data elements is performed so that when two items with which two data elements are associated, respectively, are not connected to each other with a relationship line despite that the relevance between the two data elements is high, a display element is displayed to connect the two items to each other. At that time, the display element connecting the two items to each other may be displayed in a different form from the relationship line between the two items (e.g., different thickness, line type or color), and may be displayed in a form according to the relevance between the two data elements associated with the two items, respectively.

For example, the display element may be a link-shaped figure (link object) and may be displayed with a thickness according to the relevance. In FIG. 17, a link object 411 is displayed between the item “diameter” with which the data element “S_DIAMETER” is associated and the item “flow path width” with which the data element “P_WIDTH” is associated, a link object 412 is displayed between the item “diameter” with which the data element “S_DIAMETER” is associated and the item “reed width” with which the data element “L_WIDTH” is associated, and a link object 413 is displayed between the item “diameter” with which the data element “S_DIAMETER” is associated and the item “reed curvature” with which the data element “L_CURVATURE” is associated. These link objects 411 to 413 have the same thickness. This indicates that the relevance between the data elements “S_DIAMETER” and “P_WIDTH,” the relevance between the data elements “S_DIAMETER” and “L_WIDTH,” and the relevance between the data elements “S_DIAMETER” and “L_CURVATURE” are substantially the same.

In this example, the item “diameter” is an example of a first item, and the data element “S_DIAMETER” is an example of first data associated with the first item. In addition, when the item “flow path width” is an example of a second item, the data element “P_WIDTH” is an example of second data associated with the second item, and the link object 411 is an example of the display element indicating the second data relevant to the first data or the display element indicating the relevance between the first data and the second data. When the item “reed width” is an example of the second item, the data element “L_WIDTH” is an example of the second data associated with the second item, and the link object 412 is an example of the display element indicating the second data relevant to the first data or the display element indicating the relevance between the first data and the second data. When the item “reed curvature” is an example of the second item, the data element “L_CURVATURE” is an example of the second data associated with the second item, and the link object 413 is an example of the display element indicating the second data relevant to the first data or the display element indicating the relevance between the first data and the second data. In addition, while each link object is displayed to link two items to each other, the display of the link object is not limited thereto. The link object may be displayed in association with two items.

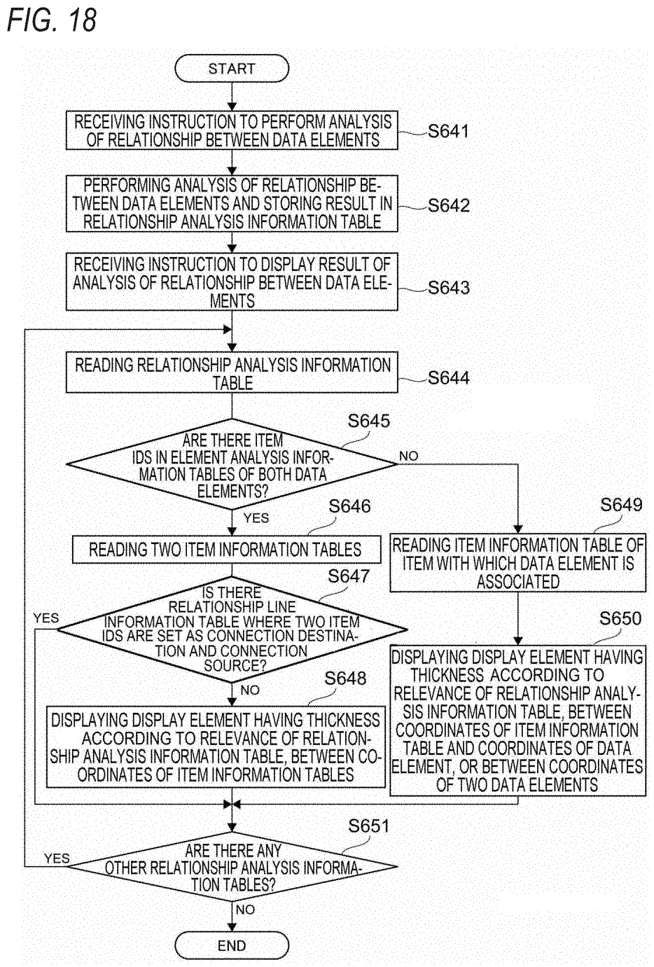

FIG. 18 is a flowchart illustrating an example of a processing according to the present exemplary embodiment; In FIG. 17, the two data elements of which the relationship is analyzed by the analysis of a relationship between data elements are associated with the items, respectively. However, hereinafter, descriptions will be made in consideration of a case where one or both of the two data elements are not associated with items.

In the information processing apparatus 100, first, the analysis module 175 receives an instruction to perform the analysis of a relationship between data elements (step S641).

Accordingly, the analysis module 175 performs the analysis of a relationship between data elements instructed in step S641, and stores the result in the relationship analysis information table 1300 (step S642). For example, the relationship analysis information table 1300 is generated for each pair having two data elements, a pair ID of the pair having the two data elements is set in the pair ID field 1305, a data element ID of a first data element of the two data elements is set in the first data element ID field 1310, a data element ID of a second data element of the two data elements is set in the second data element ID field 1315, and the relevance between the two data elements is set in the relevance field 1320.

Subsequently, the analysis information processing module 165 receives an instruction to display the result of the analysis of the relationship between the data elements (step S643).

Accordingly, the analysis information processing module 165 reads the relationship analysis information table 1300 for the pair having the two data elements, from the analysis information storage module 150 (step S644). For example, one pair ID is selected in an order of a pair ID, and the relationship analysis information table 1300 corresponding to the pair ID is read.

Subsequently, the analysis information processing module 165 reads the element analysis information table 1200 for the first data element and the element analysis information table 1200 for the second data element, based on the first data element ID and the second data element ID set in the relationship analysis information table 1300 read in step S644, and determines whether items IDs have been set in the item ID fields 1215 of the two element analysis information tables 1200 (step S645). When it is determined that item IDs have been set in the item ID fields 1215 of the two element analysis information tables 1200, both of the first data element and the second data element have been associated with items, and thus, the analysis information processing module 165 reads the two item information tables 1000 for the two item IDs (step S646).

Subsequently, the analysis information processing module 165 determines whether there exists a relationship line information table 1100 where the two item IDs determined in step S645 to have been set in the two element analysis information tables 1200 are set in the connection source item ID field 1110 and the connection destination item ID field 1115 (step S647). When it is determined that the relationship line information table 1100 does not exist, the output module 170 displays a display element having the thickness according to the relevance set in the relevance field 1320 of the relationship analysis information table 1300 to connect the two sets of coordinates to each other that are set in the coordinate fields 1015 of the two items information tables 1000, respectively, read in step 646 (step 648). Here, the description “displaying a display element to connect coordinates” means displaying the display element to connect the positions related to the coordinates to each other. That is, it is not required to display the display element to the extent that both the ends of the display element exactly coincide with the coordinates, and for example, the display element may be displayed to the extent that an overlapping portion exists between the figures indicating the items and both the ends of the display element.

Meanwhile, when it is determined in step S645 that no item IDs have been set in the item ID fields 1215 of the two element analysis information tables 1200, at least one of the first data element and the second data element has not been associated with an item, and thus, the analysis information processing module 165 reads the item information table 1000 for the item with which one of the first data element and the second data element is associated (step S649). Then, the output module 170 displays a display element having the thickness according to the relevance set in the relevance field 1320 of the relationship analysis information table 1300, to connect the coordinates set in the coordinate field 1015 of the item information table 1000 read in step S648 to arbitrary coordinates where the display element indicating the data element determined in step S645 to have not been associated with an item is displayed, or connect two arbitrary sets of coordinates where two display elements indicating the two data elements determined in step S645 to have not been associated with items are displayed, to each other (step S650). Here, the description “displaying a display element to connect coordinates” means displaying the display element to connect the positions related to the coordinates to each other. That is, it is not required to display the display element to the extent that both the ends of the display element exactly coincide with the coordinates, and for example, the display element may be displayed to the extent that an overlapping portion exists between the figures indicating the items or data elements and both the ends of the display element.

In addition, when it is determined in step S647 that there exists the relationship line information table 1100 where the two item IDs determined to have been set in the two element analysis information tables 1200 are set in the connection source item ID field 1110 and the connection destination item ID field 1115, a relationship line has already been displayed between the items of the two item IDs. Thus, the output module 170 does not display the display element, and the proceeding proceeds to step S651.

Then, the analysis information processing module 165 determines whether there exist any other relationship analysis information tables 1300 that have not been read (step S651). When the analysis information processing module 165 determines that there exist other relationship analysis information tables 1300 that have not been read, the processing returns to step S644, and when the analysis information processing module 165 determines that there exist no other relationship analysis information tables 1300 that have not been read, the processing is ended.

Next, descriptions will be made on a processing of outputting the result of the analysis of data elements including a data element which is not associated with an item.

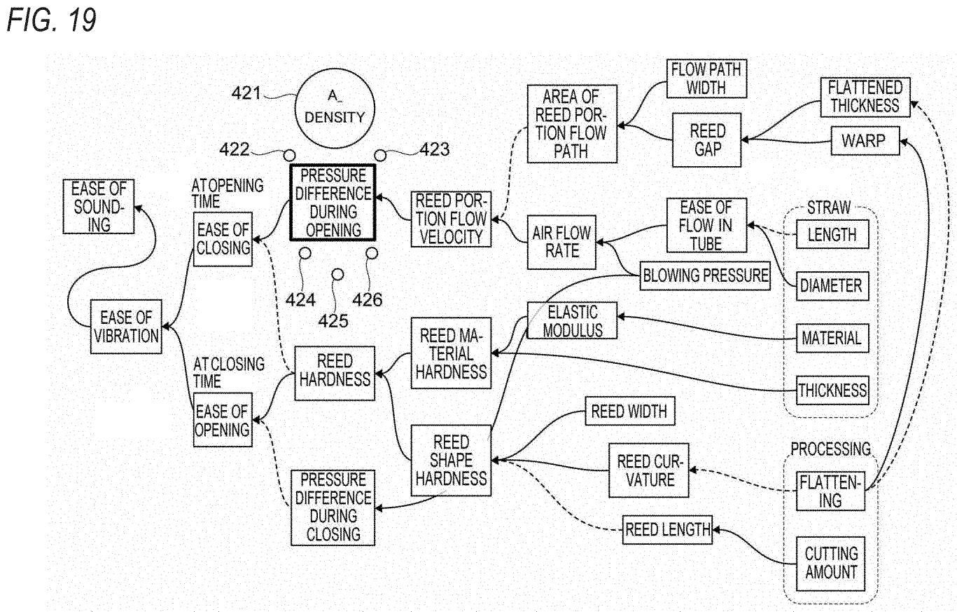

FIG. 19 is an explanatory diagram illustrating an example of a processing on the relationship diagram according to the present exemplary embodiment.

In FIG. 19, the item “pressure difference during opening” (data element “O_PRESSURE”) is selected as the analysis target (the item “pressure difference during opening” is indicated to be surrounded by a thick line in FIG. 19), as illustrated in FIG. 13. Further, it is assumed that the associating operation illustrated in FIG. 13 has been performed.

In this state, the analysis of data elements is performed. According to the present exemplary embodiment, in the analysis of data elements, for example, the analysis target may be a data element which is not associated with any item, other than the data elements assigned with the symbol “◯” in the “analysis target designation” field of the data set table 1400 of FIG. 14B. For example, the target of the analysis of the correlation with the data element “O_PRESSURE” associated with the item “pressure difference during opening” selected as the analysis target may be all of the data elements “A_DENSITY,” “A_FLOW,” “A_HUMIDITY” . . . that exist in the data set table 1400, and the importance of each of the analysis target data elements is calculated. A display element indicating the data element having the relatively high importance (contribution degree) to the analysis target is displayed. At that time, the display element indicating the data element may be displayed in a different form (e.g., different shape, color or transparency) from the item, and may be displayed in a form according to the importance (contribution degree) of the data element with respect to the analysis target data element.

For example, the display element may be displayed by a bubble-shaped figure (bubble object) having a size according to the importance (contribution degree). In FIG. 19, bubble objects 421 to 426 are displayed around the analysis target item “pressure difference during opening,” and among the bubble objects, the bubble object 421 indicates the data element “A_DENSITY.” Among the bubble objects 421 to 426, the bubble object 421 is the largest, and the bubble objects 422 to 426 are smaller than the bubble object 421. This indicates that the data element “A_DENSITY” has the highest importance (contribution degree) with respect to the data element “O_PRESSURE.” and the other data elements have the relatively low importance. Since the bubble objects 422 to 426 are displayed in the relatively small size as described above, the names of the data elements indicated by the bubble objects 422 to 426 are omitted.

In this example, the item “pressure difference during opening” is an example of a specific item, and the data element “O_PRESSURE” is an example of first data associated with the specific item. In addition, when the data element “A_DENSITY” is an example of second data which is not associated with any item, the bubble object 421 is an example of the display element indicating the second data relevant to the first data or the display element indicating the importance of the second data with respect to the first data. In addition, while the bubble objects are displayed around the item the display of the bubble objects is not limited thereto. The bubble objects may be displayed in association with items.

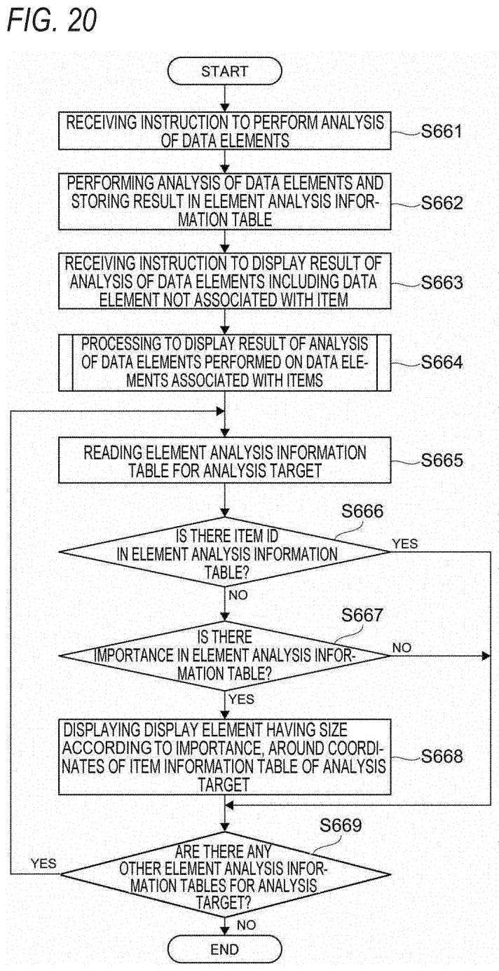

FIG. 20 is a flowchart illustrating an example of a processing according to the present exemplary embodiment:

In the information processing apparatus 100, first, the analysis module 175 receives an instruction to perform the analysis of data elements (step S661). At that time, the instruction to perform the analysis of data elements includes designation of the analysis target data element as well.

Accordingly, the analysis module 175 performs the analysis of data elements instructed in step S661, and stores the result in the element analysis information table 1200 (step S662). For example, for each data element, the element analysis information table 1200 for the data element is read from the analysis information storage module 150, the data element ID of the analysis target data element is set in the analysis target field 1220, and the importance of the data element with respect to the analysis target data element is set in the importance field 1225.

Subsequently, the analysis information processing module 165 receives an instruction to display the result of the analysis of data elements including a data element which is not associated with an item (step S663). At that time, the instruction to display the result of the analysis of data elements includes designation of the analysis target item as well.

Accordingly, first, the analysis information processing module 165 performs a processing of displaying the result of the analysis of data elements performed on the data elements associated with the items as illustrated in steps S624 to S629 of FIG. 16 (step S664).

Subsequently, the analysis information processing module 165 reads the element analysis information table 1200) for an arbitrary data element, among the element analysis information tables 1200 each set with the data element ID of the analysis target data element in the analysis target field 1220, from the relationship diagram storage module 145 (step S665). For example, one data element ID is selected in an order of a data element ID, and the element analysis information table 1200 corresponding to the data element ID is read.

Subsequently, the analysis information processing module 165 determines whether an item ID has been set in the item ID field 1215 of the element analysis information table 1200 read in step S665 (step S666). When it is determined that no item ID has been set in the item ID field 1215 of the element analysis information table 1200, the data element has not been associated with an item, and thus, the analysis information processing module 165 determines whether the importance has been set in the importance field 1225 of the element analysis information table 1200 (step S667). When the analysis of data elements in steps S661 and S662 and the display of the result of the analysis of data elements in steps S663 to S669 are performed in series, the importance has been necessarily set in the importance field 1225 of the element analysis information table 1200. Thus, in this case, the determination in step S667 does not need to be performed. However, since the analysis of data elements in steps S661 and S662 and the display of the result of the analysis of data elements in steps S663 to S669 may be performed with a time interval or may be performed by different user terminals (e.g., 210A and 210B), the determination in step S667 is performed. When it is determined that the importance has been set in the importance field 1225 of the element analysis information table 1200, the output module 170 displays a display element having the size according to the importance around the coordinates set in the coordinate field 1015 of the item information table 1000 for the analysis target item (step S668).

In addition, when it is determined in step S666 that an item ID has been set in the item ID field 1215 of the element analysis information table 1200 or when it is determined in step S667 that the importance has not been set in the importance field 1225 of the element analysis information table 1200, the output module 170 does not display the display element, and the processing proceeds to step S669.

Then, the analysis information processing module 165 determines whether there exist any other element analysis information tables 1200 that have not been read, among the element analysis information tables 1200 each set with the data element ID of the analysis target data element in the analysis target field 1220 (step S669). When the analysis information processing module 165 determines that there exist other element analysis information tables 1200 that have not been read, the processing returns to step S665, and when the analysis information processing module 165 determines that there exist no other element analysis information tables 1200 that have not been read, the processing is ended.

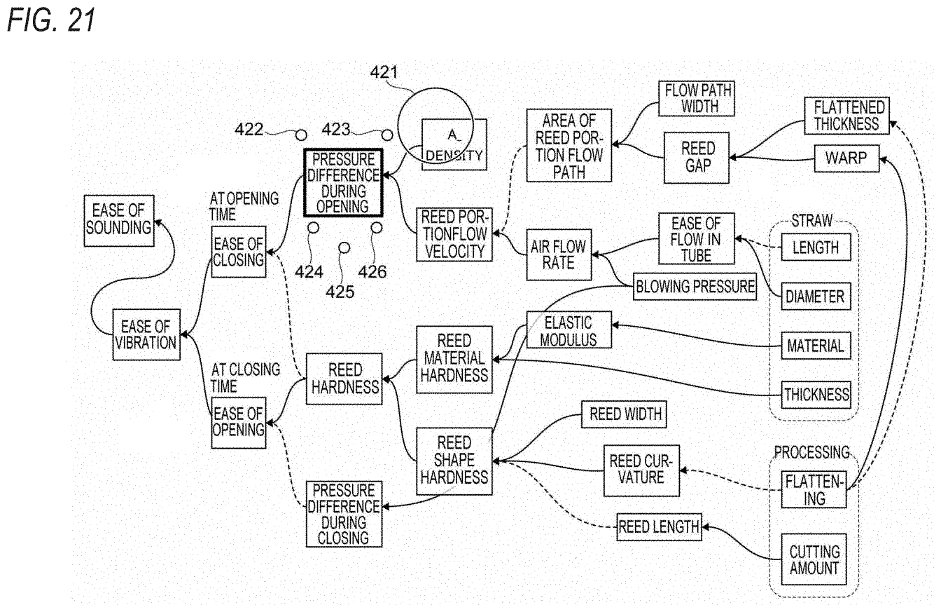

FIG. 21 is an explanatory diagram illustrating an example of a processing on the relationship diagram according to the present exemplary embodiment.

In FIG. 21, an item obtained by converting a display element is displayed as one of multiple items in the relationship diagram.

For example, in the state of FIG. 19, it is assumed that an instruction to convert the bubble object 421 indicating the data element “A_DENSITY” into an item in the relationship diagram. Then, as illustrated in FIG. 21, a provisional item having the item name “A_DENSITY” is generated and is connected to the analysis target item “pressure difference during opening” by a relationship line. In addition, since it is assumed that the bubble objects 422 to 426 have not been instructed to be converted into items in the relationship diagram, the display states of the bubble objects 422 to 426 are not changed.

In addition, descriptions will be made on a processing when the analysis of a relationship between data elements is instructed along with designation of a relationship line between items.

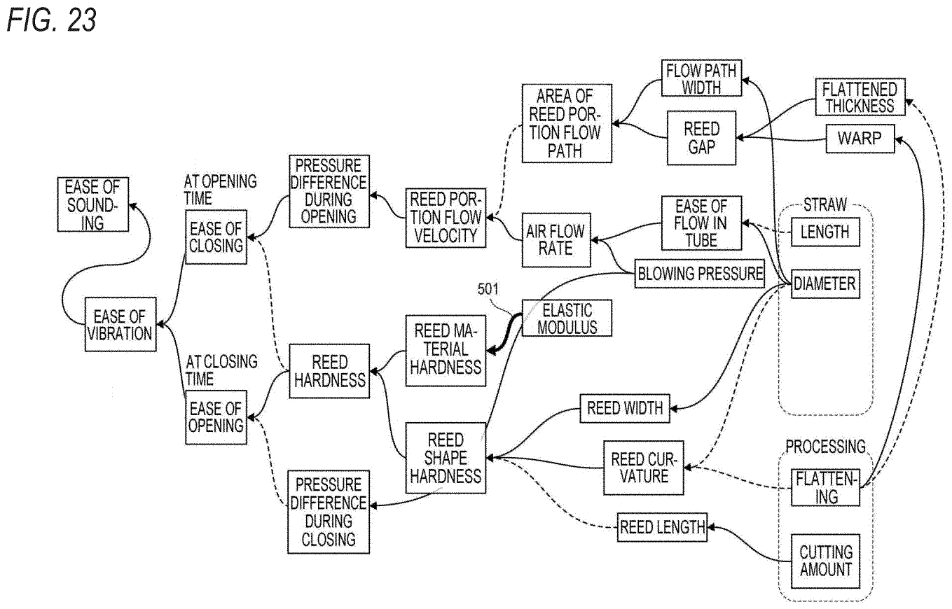

FIG. 23 is an explanatory view illustrating an example of a processing on a relationship diagram according to the present exemplary embodiment;

In FIG. 23, it is assumed that the associating operation illustrated in FIG. 13 has been performed.

In this state, a relationship line between arbitrary items is designated as a relationship line to be fixed. In FIG. 23, a relationship line 501 between items “reed material hardness” and “elastic modulus” is designated as the relationship line to be fixed (indicated in a thick line).

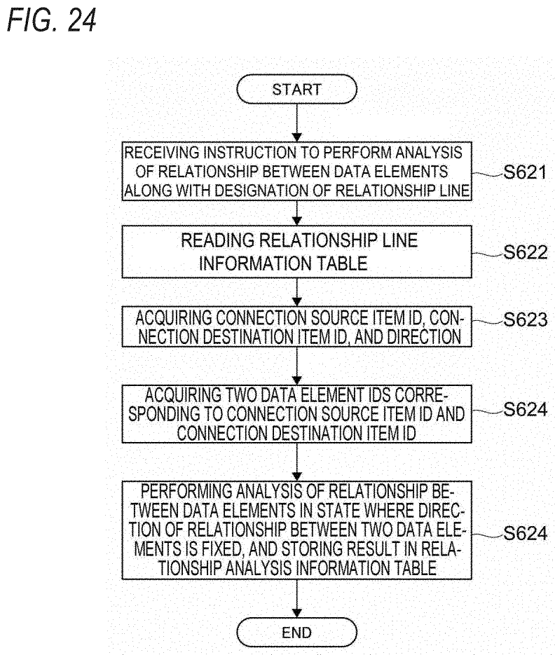

FIG. 24 is a flowchart illustrating an example of a processing according to the present exemplary embodiment;

In the information processing apparatus 100, first, the relationship fixing module 180 receives an instruction to perform the analysis of a relationship between data elements along with designation of a relationship line between items in the relationship diagram (step S621).

Accordingly, the relationship fixing module 180 reads the relationship line information table 1100 for the relationship line designated in step S621 (step S622).

Subsequently, the relationship fixing module 180 acquires the connection source item ID set in the connection source item ID field 1110, and the connection destination item ID set in the connection destination item ID field 1115, and the direction among the attributes set in the attribute field 1120, from the relationship line information table 1100 (step S623).

Subsequently, the relationship fixing module 180 acquires the data element ID set in the data element ID field 1040 from the item information table 1000 corresponding to the connection source item ID acquired in step S623, and the data element ID set in the data element ID field 1040 from the item information table 1000 corresponding to the connection destination item ID acquired in step S623 (step S624).

Then, the analysis module 175 performs the analysis of a relationship between data elements in a state where the direction of the relationship between the two data elements acquired in step S624 is fixed to the direction acquired in step S623, and stores the result in the relationship analysis information table 1300 (step S625). For example, the relationship analysis information table 1300 is generated for each pair having two data elements, a pair ID of the pair having the two data elements is set in the pair ID field 1305, a data element ID of a first data element of the two data elements is set in the first data element ID field 1310, a data element ID of a second data element of the two data elements is set in the second data element ID field 1315, and the relevance between the two data elements is set in the relevance field 1320.

Next, descriptions will be made on a processing of outputting the result of the analysis of a relationship between data elements, on the relationship diagram.

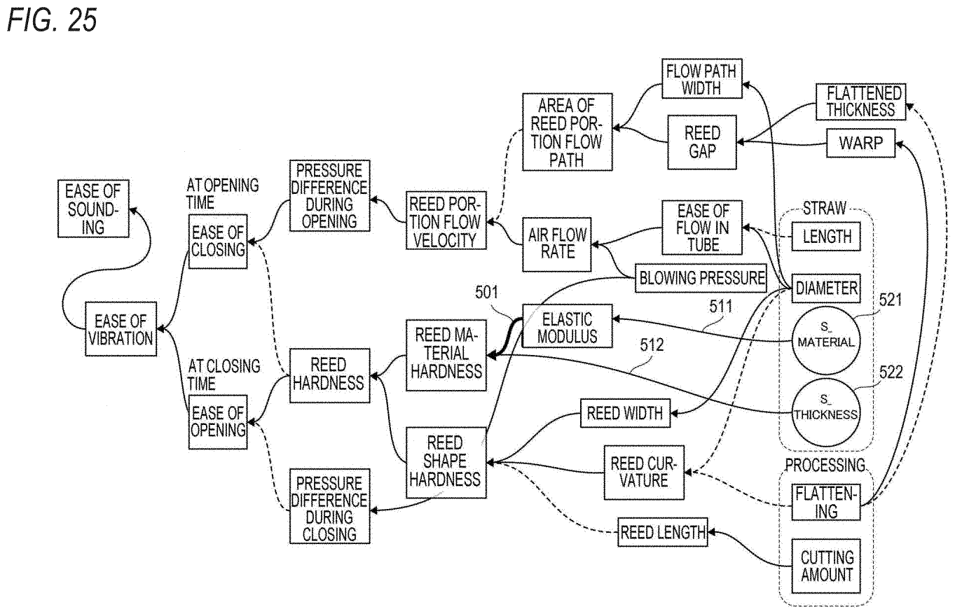

FIG. 25 is an explanatory view illustrating an example of a processing on the relationship diagram according to the present exemplary embodiment.

In FIG. 25 as well, it is assumed that the associating operation illustrated in FIG. 13 has been performed. Further, it is assumed that a relationship line between arbitrary items has been designated as a relationship line to be fixed as shown in FIG. 23.

For example, it is assumed that the relationship line 501 from the item “elastic modulus” toward the item “reed material hardness” has been designated as the relationship line to be fixed.

In this state, the analysis of a relationship between data elements is performed while the relationship line is fixed, and a display element indicating the result is displayed.

For example, the display element indicating a data element may be displayed by a bubble-shaped figure (bubble object), and the display element indicating a relationship having the directionality between an item and a data element may be displayed by an arrow-shaped figure (arrow object). In FIG. 25, an arrow object 511 is displayed to be directed from a bubble object 521 indicating the data element “S_MATERIAL” toward the item “elastic modulus” with which the data element “L_ELASTICITY” is associated, and an arrow object 512 is displayed to be directed from a bubble object 522 indicating the data element “S_THICKNESS” toward the item “reed material hardness” with which the data element “L_MATERIAL” is associated.

In addition, in this example, when the item “elastic modulus” is an example of a specific item, the data element “L_ELASTICITY” is an example of first data associated with the specific item. When the item “reed material hardness” is an example of a specific item, the data element “L_MATERIAL” is an example of the first data associated with the specific item. In addition, when the data element “S_MATERIAL” is an example of second data which is not associated with any item, the arrow object 511 is an example of the display element indicating the second data relevant to the first data or the display element indicating the directionality between the first data and the second data. When the data element “S_THICKNESS” is an example of the second data which is not associated with any item, the arrow object 512 is an example of the display element indicating the second data relevant to the first data or the display element indicating the directionality between the first data and the second data. In addition, here, while the arrow object is displayed to be connected between an item and a data element, the display of the arrow object is not limited thereto. The arrow object may be displayed in association with an item and a data element.

Alternatively, an arrow object may be displayed between items with which data elements are associated. For example, an arrow object may be displayed between the item “elastic modulus” with which the data element “L_ELASTICITY” is associated and the item “diameter” with which the data element “S_DIAMETER” is associated.

In addition, in this example, the item “elastic modulus” is an example of a first item, and the data element “L_ELASTICITY” is an example of first data associated with the first item. In addition, the item “diameter” is an example of a second item, the data element “S_DIAMETER” is an example of second data associated with the second item, and the arrow object between the items “elastic modulus” and “diameter” is an example of the display element indicating the second data relevant to the first data or the display element indicating the directionality between the first data and the second data.

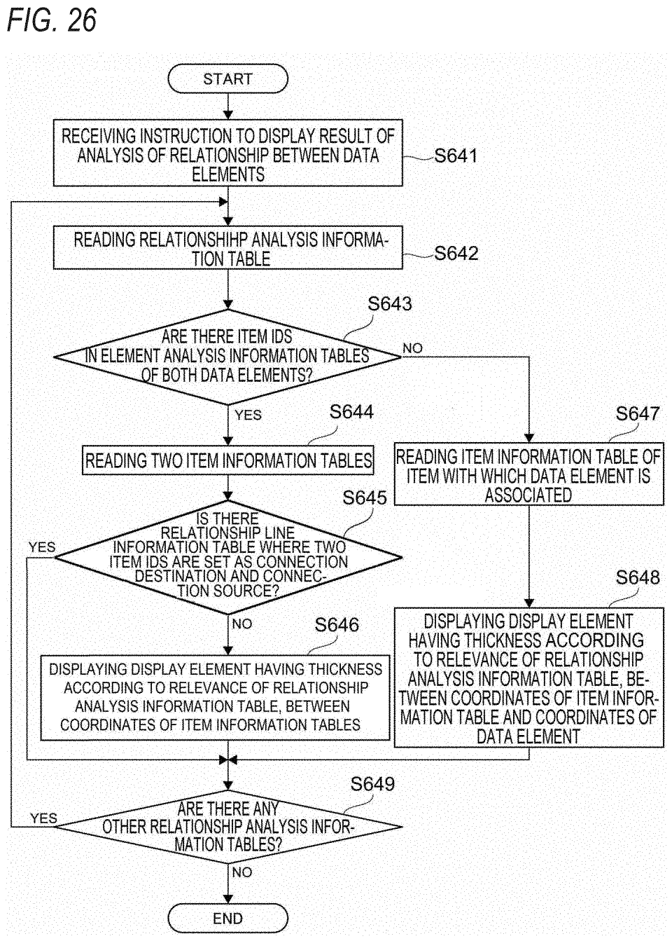

FIG. 26 is a flowchart illustrating an example of a processing according to the present exemplary embodiment; and In FIG. 25, it is assumed that only one of the two data elements of which the relationship is analyzed by the analysis of a relationship between data elements is associated with an item. However, hereinafter, descriptions will be made in consideration of a case where both of the data elements are associated with items.

In the information processing apparatus 100, first, the analysis information processing module 165 receives an instruction to display the result of the analysis of a relationship between data elements (step S641).

Accordingly, the analysis information processing module 165 reads the relationship analysis information table 1300 for a pair having two arbitrary data elements from the analysis information storage module 150 (step S642). For example, one pair ID is selected in an order of a pair ID, and the relationship analysis information table 1300 corresponding to the pair ID is read.

Subsequently, based on the first data element ID and the second data element ID set in the relationship analysis information table 1300 read in step S642, the analysis information processing module 165 reads the element analysis information table 1200 for the first data element and the element analysis information table 1200 for the second data element, and determines whether item IDs have been set in the item ID fields 1215 of the two element analysis information tables 1200 (step S643). When it is determined that item IDs have been set in the item ID fields 1215 of the two element analysis information tables 1200, both of the first data element and the second data element have been associated with items. Thus, the analysis information processing module 165 reads two item information tables 1000 for the two item IDs (step 644).

Subsequently, the analysis information processing module 165 determines whether there exists the relationship line information table 1100 where the two item IDs determined in step S643 to have been set in the two element analysis information tables 1200 are set in the connection source item ID field 1110 and the connection destination item ID field 1115 (step S645). When it is determined that the relationship line information table 1100 does not exist, the output module 170 displays a display element having the thickness according to the relevance set in the relevance field 1320 of the relationship analysis information table 1300, to connect the two sets of coordinates set in the coordinate fields 1015 of the two item information tables 1000, respectively, read in step S644 (step S646). Here, the description “displaying a display element to connect coordinates” means displaying the display element to connect the positions related to the coordinates to each other. That is, it is not required to display the display element to the extent that both the ends of the display element exactly coincide with the coordinates, and for example, the display element may be displayed to the extent that an overlapping portion exists between the figures indicating the items and both the ends of the display element.

Meanwhile, when it is determined in step S643 that no item IDs have been set in the item ID fields 1215 of the two element analysis information tables 1200, at least one of the first data element and the second data element has not been associated with an item, and thus, the analysis information processing module 165 reads the item information table 1000 for the item with which one of the first data element and the second data element is associated (step S647). Then, the output module 170 displays a display element having the thickness according to the relevance set in the relevance field 1320 of the relationship analysis information table 1300, to connect the coordinates set in the coordinate field 1015 of the item information table 1000 read in step S647 to arbitrary coordinates where the display element indicating the data element determined in step S643 to have not been associated with an item is displayed (step S648). Here, the description “displaying a display element to connect coordinates” means displaying the display element to connect the positions related to the coordinates to each other. That is, it is not required to display the display element to the extent that both the ends of the display element exactly coincide with the coordinates, and for example, the display element may be displayed to the extent that an overlapping portion exists between the figures indicating the items or data elements and both the ends of the display element.

In addition, when it is determined in step S645 that there exists the relationship line information table 1100 where the two item IDs determined to have been set in the two element analysis information tables 1200 are set in the connection source item ID field 1110 and the connection destination item ID field 1115, a relationship line has already been displayed between the two item IDs, the output module 170 does not display the display element, and the processing proceeds to step S649.

Then, the analysis information processing module 165 determines whether there exist any other relationship analysis information tables 1300 that have not been read (step S649). When the analysis information processing module 165 determines that there exist other relationship analysis information tables 1300 that have not been read, the processing returns to step S642, and when the analysis information processing module 165 determines that there exist no other relationship analysis information tables 1300 that have not been read, the processing is ended.

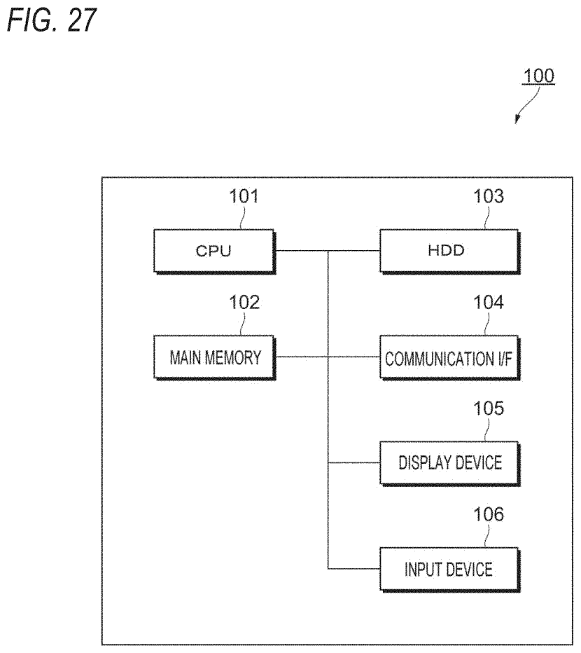

FIG. 27 is an explanatory view illustrating an example of a hardware configuration of the present exemplary embodiment.

The information processing apparatus 100 includes a CPU 101 which is an arithmetic operation unit, and a main memory 102 and a hard disk drive (HDD) 103 which are storage units. Here, the CPU 101 executes various pieces of software such as an operating system (OS) and an application, so as to implement the respective processing modules described above. In addition, the main memory 102 stores, for example, the various pieces of software or data used for the execution of the various pieces of software, the HDD 103 stores, for example, data input to the various pieces of software and data output from the various pieces of software, and one or both of the main memory 102 and the HDD 103 implement each storage module. Further, the information processing apparatus 100 includes a communication interface (communication I/F) 104 for communicating with the outside, a display device 105 such as a display, and an input device 106 such as a keyboard or a mouse.

The processing executed in the information processing apparatus 100 according to the present exemplary embodiment is prepared by, for example, a program such as application software.

The program for implementing the present exemplary embodiment is a relationship diagram generated according to an operation by an operator on a computer, and is regarded as a program for implementing a function to display a relationship diagram expressing a relationship between multiple items by connecting the multiple items together with relationship lines, and a function to output a display element indicating second data relevant to first data corresponding to an item in such a way that the display element is displayed on the relationship diagram.

Further, the program for implementing the present exemplary embodiment is also regarded as a program for implementing a function to display a relationship diagram expressing a relationship between multiple items by connecting the multiple items together with relationship lines, a function to receive designation of a specific relationship line between multiple items, and a function to output a display element indicating second data relevant to first data corresponding to an item in such a way that the display element is displayed on the relationship diagram without causing any inconsistency with the specific relationship line.

The program for implementing the present exemplary embodiment may be provided by a communication unit or may be provided in a state of being stored in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display unit configured to display a relationship diagram that is created according to an operation by an operator and expresses a relationship between a plurality of items by connecting the plurality of items together with relationship lines; and
an output unit configured to output a display element indicating second data relevant to first data corresponding to at least one of the plurality of items in such a way that the display element is displayed on the relationship diagram.

2. The information processing apparatus according to claim 1, wherein
the first data is associated with a first item of the plurality of items, and
the second data is associated with a second item of the plurality of items.

3. The information processing apparatus according to claim 2, wherein
the display element further indicates an importance of the second data with respect to the first data.

4. The information processing apparatus according to claim 3, wherein
the output unit outputs the display element in association with the second item.

5. The information processing apparatus according to claim 3, wherein
the output unit outputs the display element in such a way that the display element is displayed in a different form from the plurality of items.

6. The information processing apparatus according to claim 3, wherein
the output unit outputs the display element in such a way that the display element is displayed in a form according to the importance.

7. The information processing apparatus according to claim 2, wherein
the display element further indicates a relevance between the first data and the second data.

8. The information processing apparatus according to claim 7, wherein
the output unit outputs the display element in such a way that the display element is displayed in association with the first item and the second item.

9. The information processing apparatus according to claim 7, wherein
the output unit outputs the display element in such a way that the display element is displayed in a different form from the relationship lines between the plurality of items.

10. The information processing apparatus according to claim 7, wherein the output unit outputs the display element in such a way that the display element is displayed in a form according to the relevance.

11. The information processing apparatus according to claim 2, further comprising an association unit configured to associate the first data and the second data with the first item and the second item, respectively.

12. The information processing apparatus according to claim 1, wherein
the first data is associated with a specific item of the plurality of items, and
the second data is not associated with any of the plurality of items.

13. The information processing apparatus according to claim 12, wherein
the display element further indicates an importance of the second data with respect to the first data.

14. The information processing apparatus according to claim 13, wherein
the output unit outputs the display element in such a way that the display element is displayed in a different form from the plurality of items.

15. The information processing apparatus according to claim 13, wherein
the output unit outputs the display element in such a way that the display element is displayed in a form according to the importance.

16. The information processing apparatus according to claim 13, wherein
the display unit displays, as one of the plurality of items in the relationship diagram, an item obtained by converting the display element.

17. A non-transitory computer readable medium storing a program causing a computer to execute information processing, the information processing comprising:
displaying a relationship diagram that is created according to an operation by an operator and expresses a relationship between a plurality of items by connecting the plurality of items together with relationship lines; and
outputting a display element indicating second data relevant to first data corresponding to at least one of the plurality of items in such a way that the display element is displayed on the relationship diagram.

18. An information processing apparatus comprising:
a display unit configured to display a relationship diagram that expresses a relationship between a plurality of items by connecting the plurality of items together with relationship lines;
a receiving unit configured to receive designation of a specific relationship line between the plurality of items; and
an output unit configured to output a display element indicating second data relevant to first data corresponding to at least one of the plurality of items in such a way that the display element is displayed on the relationship diagram without causing inconsistency with the specific relationship line.

19. The information processing apparatus according to claim 18, wherein
the output unit outputs a display element according to an attribute of the specific relationship line in such a way that the display element is displayed on the relationship diagram.

20. The information processing apparatus according to claim 19, wherein
the attribute is a direction of the specific relationship line.

21. The information processing apparatus according to claim 18, wherein
the output unit outputs a display element having an attribute according to the specific relationship line in such a way that the display element is displayed on the relationship diagram.

22. The information processing apparatus according to claim 21, wherein
the attribute is a direction of the display element.

23. The information processing apparatus according to claim 18, wherein
the first data is associated with a first item of the plurality of items, and
the second data is associated with a second item of the plurality of items.

24. The information processing apparatus according to claim 23, wherein
the display element indicates a directionality between the first data and the second data.

25. The information processing apparatus according to claim 18, wherein
the first data is associated with a specific item of the plurality of items, and
the second data is not associated with any of the plurality of items.

26. The information processing apparatus according to claim 25, wherein
the display element indicates a directionality between the first data and the second data.
